(19) United States
(12) Patent Application Publication
(10) Pub. No.: US 2025/0218626 A1
(43) Pub. Date: Jul. 3, 2025

(54) CHIP VARISTOR

(71) Applicant: TDK Corporation, Tokyo (JP)

(72) Inventors: Masayuki Uchida, Tokyo (JP); Koki Shinozawa, Tokyo (JP); Naoyoshi Yoshida, Tokyo (JP); Shin Kagaya, Tokyo (JP); Kazuyuki Iwata, Tokyo (JP)

(73) Assignee: TDK Corporation, Tokyo (JP)

(21) Appl. No.: 18/950,509

(22) Filed: Nov. 18, 2024

(30) Foreign Application Priority Data
Dec. 28, 2023 (JP) 2023-222547

(51) Int. Cl. H01C 7/102; H01C 1/148; H01C 7/10; H01C 7/112

(52) U.S. Cl. CPC H01C 7/102; H01C 1/148; H01C 7/1006; H01C 7/112

(57) ABSTRACT

A chip varistor includes an element body including a first and a second side surface, and a plurality of internal electrodes opposing each other in the element body. The plurality of internal electrodes include a first, a second, a third, a fourth, and a fifth internal electrode. The first internal electrode is exposed to the first side surface. The second internal electrode is exposed to the second side surface. The third internal electrode is separated from the first and the second internal electrode. The fourth internal electrode is disposed to form a plurality of varistors connected in series between the first and the third internal electrode. The fifth internal electrode is disposed to form a plurality of varistors connected in series between the second and the third internal electrode. Among the plurality of internal electrodes, the internal electrodes opposing each other include ends opposing each other and having different widths.

### CROSS-REFERENCE TO RELATED APPLICATIONS

This application is based upon and claims the benefit of priority from Japanese Patent Application No. 2023-222547, filed on Dec. 28, 2023, the entire contents of which are incorporated herein by reference.

### BACKGROUND

### Field

The present disclosure relates to a chip varistor.

### Description of the Related Art

Known chip varistors include an element body and a plurality of internal electrodes disposed in the element body and opposing each other (see e.g., Japanese Unexamined Patent Publication No. 2022-546809). The element body includes, for example, a pair of side surfaces. The plurality of internal electrodes include, for example, a pair of internal electrodes each exposed to a corresponding side surface of the pair of side surfaces, and a plurality of internal electrodes disposed to form a plurality of varistors connected in series between the pair of internal electrodes.

### SUMMARY

In the chip varistor, the varistor is formed between the internal electrodes opposing each other among the plurality of internal electrodes. Area of a region where the internal electrodes opposing each other overlap each other affects characteristics of the varistor. The area may be simply referred to as, for example, an “overlapping area”. For example, decrease in the overlapping area may deteriorate the characteristics of the varistor, that is, the characteristics of the chip varistor. The decrease in the overlapping area prevent the varistor from exhibiting desired characteristics.

An object of one aspect of the present disclosure is to provide a chip varistor capable of obtaining desired characteristics.

A chip varistor according to one aspect of the present disclosure includes an element body including a first side surface and a second side surface, and a plurality of internal electrodes disposed in the element body and opposing each other. The plurality of internal electrodes include a first internal electrode exposed to the first side surface, a second internal electrode exposed to the second side surface, a third internal electrode separated from the first internal electrode and the second internal electrode, a fourth internal electrode disposed to form a plurality of varistors connected in series between the first internal electrode and the third internal electrode, and a fifth internal electrode disposed to form a plurality of varistors connected in series between the second internal electrode and the third internal electrode. Among the plurality of internal electrodes, the internal electrodes opposing each other include ends opposing each other and having different widths.

In the one aspect, the internal electrodes opposing each other include the ends opposing each other and having the different widths. Therefore, regardless of a relative position of the internal electrodes opposing each other, the overlapping area tends not to change. As a result, the one aspect can obtain the desired characteristics.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view of a chip varistor according to an embodiment;

FIG. 2 is a diagram illustrating a cross-sectional configuration of the chip varistor according to the present embodiment;

FIG. 3 is a diagram illustrating a configuration of a plurality of internal electrodes;

FIG. 4 is a diagram illustrating a configuration of the plurality of internal electrodes;

FIG. 5 is a diagram illustrating a configuration of the plurality of internal electrodes;

FIG. 6 is a diagram illustrating a configuration of the plurality of internal electrodes;

FIG. 7 is a diagram illustrating a configuration of the plurality of internal electrodes;

FIG. 8 is a diagram illustrating a configuration of the plurality of internal electrodes;

FIG. 9 is a diagram illustrating a cross-sectional configuration of a chip varistor according to a modification of the present embodiment;

FIG. 10 is a diagram illustrating a cross-sectional configuration of a chip varistor according to another modification of the present embodiment;

FIG. 11 is a diagram illustrating a configuration of the plurality of internal electrodes;

FIG. 12 is a perspective view of a chip varistor according to still another modification of the present embodiment;

FIG. 13 is a diagram illustrating a configuration of the plurality of internal electrodes; and

FIG. 14 is a diagram illustrating a configuration of the plurality of internal electrodes.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

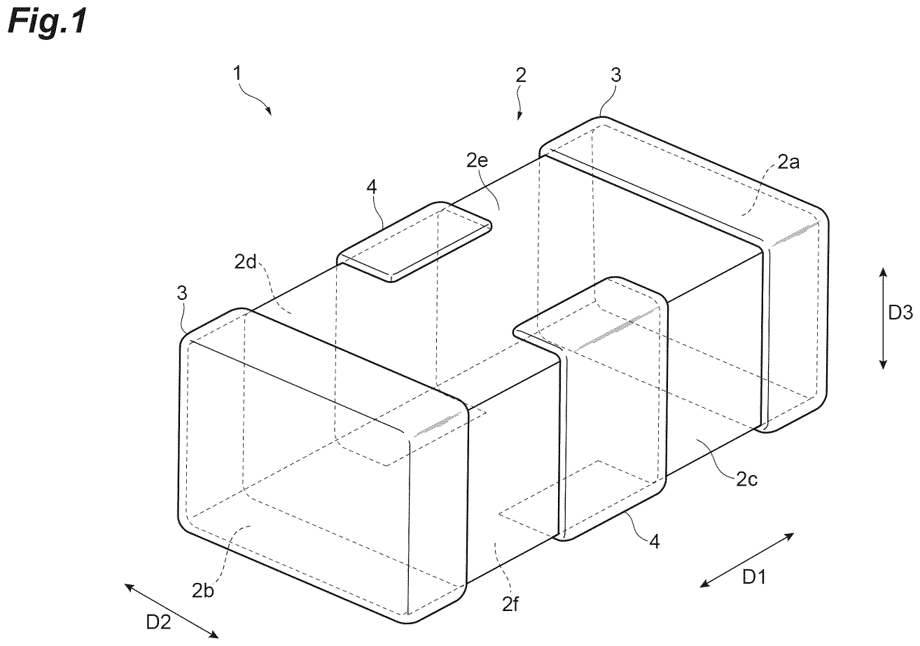

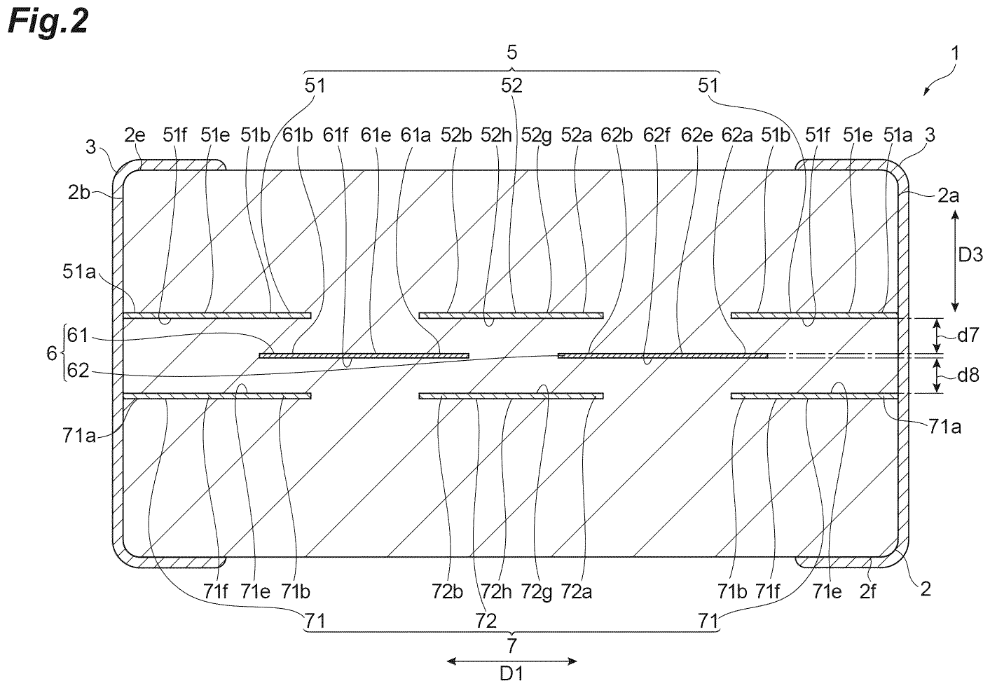

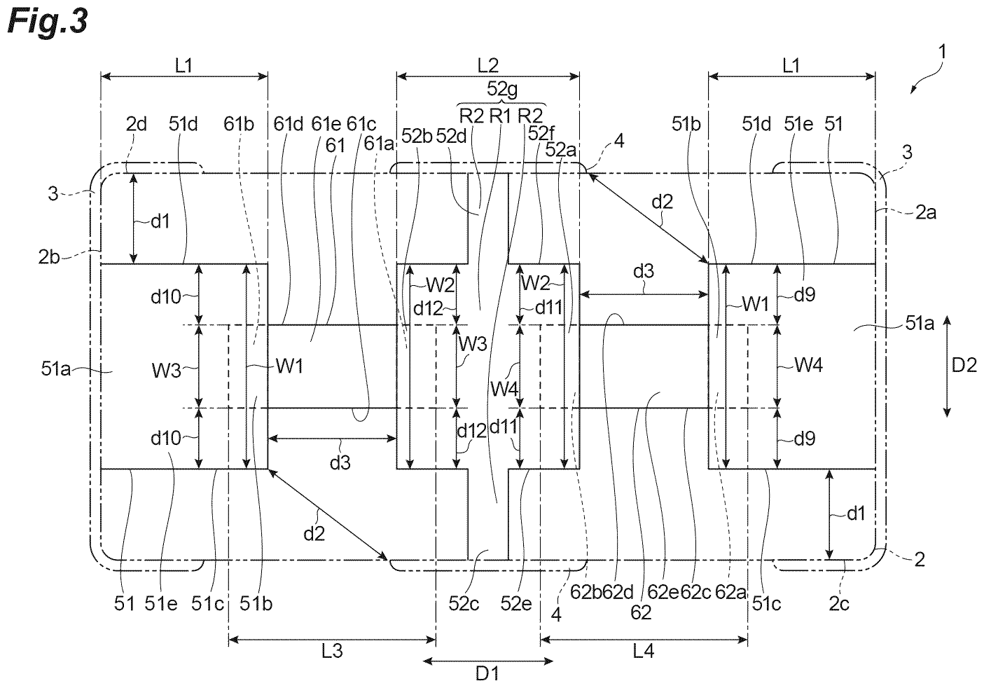

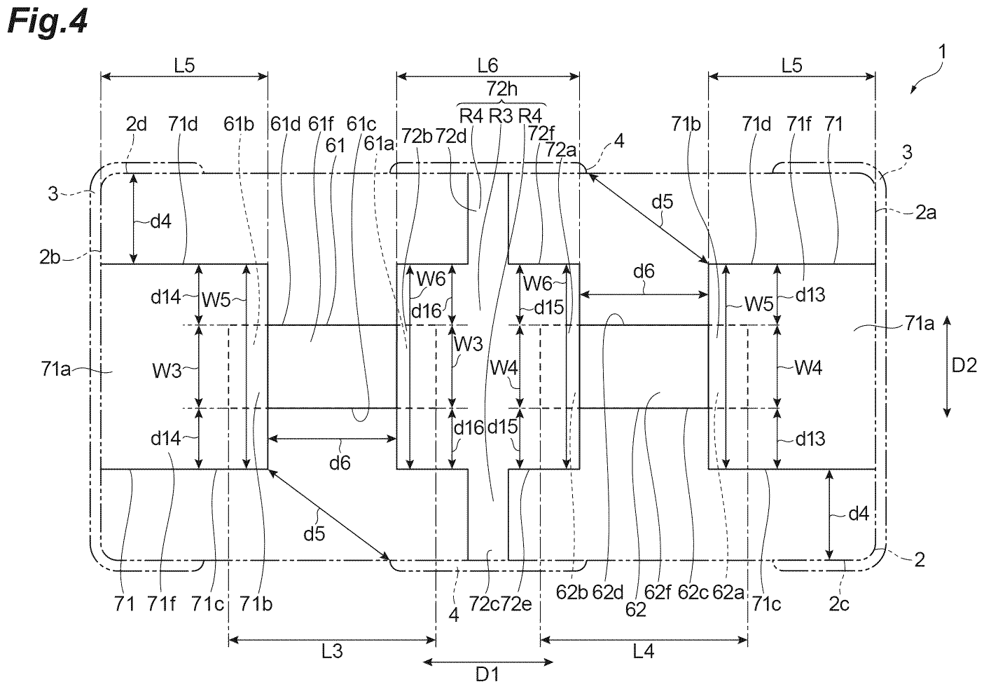

A configuration of a chip varistor 1 according to the present embodiment will be described with reference to FIGS. 1 to 4. FIG. 1 is a perspective view of a chip varistor according to the present embodiment. FIG. 2 is a diagram illustrating a cross-sectional configuration of the chip varistor according to the present embodiment. FIGS. 3 and 4 are diagrams illustrating a configuration of a plurality of internal electrodes.

As illustrated in FIG. 1, the chip varistor 1 is a three-terminal chip varistor. As illustrated in FIGS. 1 and 2, the chip varistor 1 includes an element body 2, a plurality of external electrodes, and a plurality of internal electrodes. In the chip varistor 1, the plurality of external electrodes, for example, a pair of external electrodes 3 and a pair of the external electrodes 4. The plurality of internal electrodes include, for example, an internal electrode 51, an internal electrode 52, an internal electrode 61, an internal electrode 62, an internal electrode 71, and an internal electrode 72.

The element body 2 has a rectangular parallelepiped shape. The rectangular parallelepiped shape includes, for example, a rectangular parallelepiped shape in which corner portions and ridge portions are chamfered, and a rectangular parallelepiped shape in which the corner portions and the ridge portions are rounded. The element body 2 includes a pair of side surfaces 2a and 2b opposing each other, a pair of side surfaces 2c and 2d opposing each other, and a pair of side surfaces 2e and 2f opposing each other. In the present embodiment, the pair of side surfaces 2a and 2b opposes each other in a first direction D1, the pair of side surfaces 2c and 2d opposes each other in a second direction D2, and the pair of side surfaces 2e and 2f opposes each other in a third direction D3. For example, the first direction D1, the second direction D2, and the third direction D3 cross each other. In the present embodiment, the first direction D1, the second direction D2, and the third direction D3 are orthogonal to each other.

The pair of side surfaces 2c and 2d and the pair of side surfaces 2e and 2f couple the side surface 2a and the side surface 2b. The pair of side surfaces 2c and 2d couples the side surface 2a and the side surface 2b and extends in the first direction D1. The pair of side surfaces 2c and 2d also extends in the third direction D3. The pair of side surfaces 2e and 2f couples the side surface 2a and the side surface 2b and extends in the first direction D1. The pair of side surfaces 2e and 2f also extends in the second direction D2.

The element body 2 includes a multilayer structure in which a plurality of ceramic layers are laminated. A laminating direction of the plurality of ceramic layers includes, for example, the second direction D2. Each ceramic layer includes a sintered body that exhibits characteristics of a varistor. The element body 2 includes, for example, a semiconductor ceramic material. In the actual element body 2, each ceramic layer is integrated to an extent that boundaries between the ceramic layers cannot be visually recognized. The element body 2 includes a varistor element body.

The element body 2 includes ZnO (zinc oxide) as a main component. The element body 2 includes, for example, a metal simple substance including Co, a rare earth metal element, a group IIIb element, Si, Cr, Mo, an alkali metal element, and an alkaline earth metal element as an accessory component. The rare earth metal element includes Pr. The rare earth metal element can express the characteristics of the varistor. The group IIIb elements include B, Al, Ga, and In. The alkali metal element includes K, Rb, and Cs. The alkaline earth metal element includes Mg, Ca, Sr, and Ba. The element body 2 may include an oxide of the metal simple substance as the accessory component. In the present embodiment, the element body 2 includes Co, Pr, Cr, Ca, K, and Al as the accessory components.

The first direction D1 is a length direction of the element body 2. The second direction D2 is a width direction of the element body 2. The third direction D3 is a height direction of the element body 2. A length of the element body 2 is, for example, larger than or equal to 0.95 mm and less than or equal to 1.95 mm. A width of the element body 2 is, for example, larger than or equal to 0.45 mm and less than or equal to 1.20 mm. A height of the element body 2 is, for example, larger than or equal to 0.35 mm and less than or equal to 0.85 mm. In the present embodiment, the length of the element body 2 is 1.55 mm, the width of the element body 2 is 0.75 mm, and the height of the element body 2 is 0.55 mm.

The pair of external electrodes 3 and the pair of external electrodes 4 are disposed on the element body 2. In the present embodiment, the pair of external electrodes 3 and the pair of external electrodes 4 are separated from each other.

The pair of external electrodes 3 is disposed on the element body 2. The pair of external electrodes 3 oppose each other in the first direction D1. Each of the external electrodes 3 is disposed at both end portions of the element body 2 in the first direction D1. The pair of external electrodes 3 is separated from each other in the first direction D1.

One external electrode 3 of the pair of external electrodes 3 is disposed on the side surface 2a. The other external electrode 3 of the pair of external electrodes 3 is disposed on the side surface 2b. That is, each external electrode 3 is disposed on a corresponding side surface of the pair of side surfaces 2a and 2b. The external electrode 3 covers the corresponding side surface. The external electrode 3 also covers a part of each of the side surfaces 2c, 2d, 2e, and 2f. The part of the side surface 2c covered by the external electrode 3 is positioned closer to the corresponding side surface. The part of the side surface 2d covered by the external electrode 3 is positioned closer to the corresponding side surface. The part of the side surface 2e covered by the external electrode 3 is positioned closer to the corresponding side surface. The part of the side surface 2f covered by the external electrode 3 is positioned closer to the corresponding side surface.

The pair of external electrodes 4 is disposed on the element body 2. The pair of external electrodes 4 opposes each other in the second direction D2. Each external electrode 4 is positioned between the pair of external electrodes 3 in the first direction D1. That is, the pair of external electrodes 4 is separated from each of the external electrodes 3 in the first direction D1. In the present embodiment, the pair of external electrodes 4 is positioned substantially in the middle of the pair of external electrodes 3 in the first direction D1. The pair of external electrodes 4 is separated from each other in the second direction D2.

One external electrode 4 of the pair of external electrodes 4 is disposed on the side surface 2c. The other external electrode 4 of the pair of external electrodes 4 is disposed on the side surface 2d. That is, each external electrode 4 is disposed on a corresponding side surface of the pair of side surfaces 2c and 2d. The external electrode 4 covers a part of the corresponding side surface. The part of the side surface 2c covered by the external electrode 4 is positioned substantially at a center of the side surface 2c in the first direction D1 and extended from one end to the other end of the side surface 2c in the third direction D3. The part of the side surface 2d covered by the external electrode 4 is positioned substantially at a center of the side surface 2d in the first direction D1 and extended from one end to the other end of the side surface 2d in the third direction D3.

The external electrode 4 also covers a part of each of the side surfaces 2e and 2f. The part of the side surface 2e covered by the external electrode 4 is positioned substantially at a center of the side surface 2e in the first direction D1, and is positioned closer to the corresponding side surface. The part of the side surface 2f covered by the external electrode 4 is positioned substantially at a center of the side surface 2f in the first direction D1, and is positioned closer to the corresponding side surface.

The external electrodes 3 and 4 are formed, for example, through sintering an electrically conductive paste applied to the surface of the element body 2. The electrically conductive paste includes, for example, a powder including a metal, a glass component, an organic binder, and an organic solvent. The metal includes, for example, Pd, Cu, Ag, or an Ag—Pd alloy. A plated layer may be formed on each of the external electrodes 3 and 4. The plated layer may include, for example, a Ni plated layer and a Sn plated layer formed on the Ni plated layer.

The plurality of internal electrodes are disposed in the element body 2 and oppose each other. The plurality of internal electrodes oppose each other in the third direction D3. As illustrated in FIG. 2, the plurality of internal electrodes include an internal electrode layer 5, an internal electrode layer 6, and an internal electrode layer 7.

The internal electrode layers 5, 6, and 7 are disposed in the element body 2. The internal electrode layers 5, 6, and 7 are disposed at different positions in the third direction D3 in the element body 2. The internal electrode layer 6 is adjacent to the internal electrode layer 5. The internal electrode layer 6 is adjacent to the internal electrode layer 5, for example, in the third direction D3. The internal electrode layer 7 is adjacent to the internal electrode layer 6 in such a manner that the internal electrode layer 6 is positioned between the internal electrode layer 7 and the internal electrode layer 5. That is, the internal electrode layer 6 is positioned between the internal electrode layer 5 and the internal electrode layer 7. The internal electrode layer 7 is adjacent to the internal electrode layer 6 in such a manner that the internal electrode layer 6 is positioned between the internal electrode layer 7 and the internal electrode layer 5, for example, in the third direction D3.

In the present embodiment, in the element body 2, the internal electrode layers 5, the internal electrode layers 6, and the internal electrode layers 7 are arranged in this order in the third direction D3. A position of the internal electrode layer 5 in the third direction D3 and a position of the internal electrode layer 7 in the third direction D3 may be reversed from the above-described order. That is, in the element body 2, the internal electrode layer 7, the internal electrode layer 6, and the internal electrode layer 5 may be arranged in this order in the third direction D3.

The internal electrode layer 5 includes the internal electrode 51 and the internal electrode 52. In the present embodiment, the internal electrode layer 5 includes a pair of the internal electrodes 51 and one internal electrode 52. The internal electrode 51 and the internal electrode 52 extend in the first direction D1. The internal electrode 51 and the internal electrode 52 are positioned in the same layer in the element body 2. The internal electrode 51 and the internal electrode 52 are disposed at the same position in the third direction D3. Each of the pair of internal electrodes 51 is disposed closer to the corresponding side surface of the pair of side surfaces 2a and 2b and exposed to the corresponding side surface. The internal electrode 52 is separated from the pair of internal electrodes 51 and exposed to the pair of side surfaces 2c and 2d. In the present embodiment, the internal electrode 52 is positioned between the pair of internal electrodes 51 in the first direction D1.

The internal electrode layer 6 includes the internal electrode 61 and the internal electrode 62. In the present embodiment, the internal electrode layer 6 includes one internal electrode 61 and one internal electrode 62. The internal electrode 61 and the internal electrode 62 extend in the first direction D1. The internal electrode 61 and the internal electrode 62 are positioned in the same layer in the element body 2. The internal electrode 61 and the internal electrode 62 are disposed at the same position in the third direction D3. The internal electrode 61 and the internal electrode 62 are separated from each other in the same layer, and are not exposed to an outer surface of the element body 2. The internal electrode 61 and the internal electrode 62 oppose each other in the first direction D1 in the same layer.

The internal electrode layer 7 includes the internal electrode 71 and the internal electrode 72. In the present embodiment, the internal electrode layer 7 includes a pair of the internal electrodes 71 and one internal electrode 72. The internal electrode 71 and the internal electrode 72 extend in the first direction D1. The internal electrode 71 and the internal electrode 72 are positioned in the same layer in the element body 2. The internal electrode 71 and the internal electrode 72 are disposed at the same position in the third direction D3. The pair of internal electrodes 71 is disposed closer to the corresponding side surface of the pair of side surfaces 2a and 2b and exposed to the corresponding side surface. The internal electrode 72 is separated from the pair of internal electrodes 71 and exposed to the pair of side surfaces 2c and 2d. In the present embodiment, the internal electrode 72 is positioned between the pair of internal electrodes 71 in the first direction D1.

Each of the internal electrodes 51, 52, 61, 62, 71, and 72 included in the internal electrode layers 5, 6, and 7 opposes, in the third direction D3, a corresponding internal electrode among the internal electrodes included in the adjacent internal electrode layer in the third direction D3. In the present embodiment, in the internal electrode layer 5 and the internal electrode layer 6, the internal electrode 61 opposes the internal electrode 51 exposed to the side surface 2b and the internal electrode 52 in the third direction D3. In the internal electrode layer 5 and the internal electrode layer 6, the internal electrode 62 opposes the internal electrode 51 exposed to the side surface 2a and the internal electrode 52 in the third direction D3.

In the internal electrode layer 6 and the internal electrode layer 7, the internal electrode 61 opposes the internal electrode 71 exposed to the side surface 2b and the internal electrode 72 in the third direction D3. In the internal electrode layer 6 and the internal electrode layer 7, the internal electrode 62 opposes the internal electrode 71 exposed to the side surface 2a and the internal electrode 72 in the third direction D3.

As illustrated in FIGS. 2 and 3, the internal electrode 51 includes a pair of ends 51a and 51b, a pair of end edges 51c and 51d opposing each other, and a pair of surfaces 51e and 51f opposing each other. FIG. 3 is a view of the pair of internal electrodes 51 and 52 and the internal electrodes 61 and 62 when viewed from the side surface 2e toward the side surface 2f in the third direction D3.

The pair of ends 51a and 51b defines both ends of the internal electrode 51 in the first direction D1. The end 51a is exposed to the corresponding side surface of the pair of side surfaces 2a and 2b. The end 51a is connected to the external electrode 3 disposed on the corresponding side surface. That is, the end 51a is connected to the corresponding external electrode of the pair of external electrodes 3. In the present embodiment, the end 51a is directly connected to the external electrode 3. The end 51a includes a connection end connected to the external electrode 3.

The end 51b is positioned in the element body 2 and is not exposed to the outer surface of the element body 2. The end 51b is separated from each of the side surfaces 2a and 2b. The internal electrode 51 opposes the corresponding internal electrode of the internal electrodes 61 and 62 in the third direction D3 at the end 51b. In the present embodiment, the internal electrode 51 exposed to the side surface 2a opposes the internal electrode 62 in the third direction D3 at the end 51b, and the internal electrode 51 exposed to the side surface 2b opposes the internal electrode 61 in the third direction D3. The end 51b includes a region overlapping the corresponding internal electrode when viewed from the third direction D3.

In the present embodiment, the end 51b of the internal electrode 51 exposed to the side surface 2a includes a region overlapping the internal electrode 62 when viewed from the third direction D3. In the present embodiment, the region of the end 51b of the internal electrode 51 exposed to the side surface 2a extends from an end of the internal electrode 51 to an end of the end 62a of the internal electrode 62 when viewed from the third direction D3. In the present embodiment, the end 51b of the internal electrode 51 exposed to the side surface 2b includes a region overlapping the internal electrode 61 when viewed from the third direction D3. In the present embodiment, the region of the end 51b of the internal electrode 51 exposed to the side surface 2b extends from an end of the internal electrode 51 to an end of an end 61b of the internal electrode 61 when viewed from the third direction D3.

That is, the end 51b includes the end of the internal electrode 51 and a region from the end of the internal electrode 51 to a predetermined length. Therefore, the end 51b has the predetermined length in the first direction D1. The end 51b is buried in the element body 2 and is in contact with only the element body 2.

The pair of end edges 51c and 51d opposes each other in the second direction D2, and the pair of surfaces 51e and 51f opposes each other in the third direction D3. In the present embodiment, the end edge 51c is positioned closer to the side surface 2c, and the end edge 51d is positioned closer to the side surface 2d. In the present embodiment, the surface 51c is positioned closer to the side surface 2e, and the surface 51f is positioned closer to the side surface 2f. Each of the end edges 51c and 51d may include a surface. Each of the end edges 51c and 51d is adjacent to each of the surface 51e and the surface 51f and couples the surface 51c and the surface 51f.

As illustrated in FIG. 3, the internal electrode 51 has a length L1. The length L1 includes, for example, a length of the internal electrode 51 in the first direction D1. The length L1 is, for example, larger than or equal to 0.25 mm and less than or equal to 0.5 mm. The length L1 in the present embodiment is 0.405 mm. In the present embodiment, the pair of internal electrodes 51 has the same length L1. The pair of internal electrodes 51 may have different lengths L1 from each other.

The internal electrode 51 has a width W1 at the end 51b. That is, the end 51b has the width W1. The width W1 includes, for example, a length of the internal electrode 51 in the second direction D2 at the end 51b. The width W1 is, for example, larger than or equal to 0.1 mm and less than or equal to 0.6 mm. The width W1 in the present embodiment is 0.5 mm.

In the present embodiment, the internal electrode 51 has the width W1 throughout its entirety. The internal electrode 51 only needs to have the width W1 at the end 51b. For example, the internal electrode 51 may have a width different from the width W1 at a position other than the end 51b. In the present embodiment, the pair of internal electrodes 51 has the same width W1 at each end 51b. The pair of internal electrodes 51 may have different widths W1 at each end 51b.

In the internal electrode layer 5, a distance d1 between the internal electrode 51 and the outer surface of the element body 2 is, for example, larger than or equal to 0.1 mm and less than or equal to 0.4 mm. The distance d1 in the present embodiment is 0.2 mm. The distance d1 includes, for example, a distance between the pair of end edges 51c and 51d and the corresponding side surface in the second direction D2. In the present embodiment, the distance d1 between the internal electrode 51 exposed to the side surface 2a and the outer surface of the element body 2 and the distance d1 between the internal electrode 51 exposed to the side surface 2b and the outer surface of the element body 2 are the same. The distance d1 between the internal electrode 51 exposed to the side surface 2a and the outer surface of the element body 2 and the distance d1 between the internal electrode 51 exposed to the side surface 2b and the outer surface of the element body 2 may be different from each other.

In the internal electrode layer 5, a distance d2 between the internal electrode 51 and the external electrode 4 is, for example, larger than or equal to 0.21 mm and less than or equal to 0.57 mm. The distance d2 in the present embodiment is 0.36 mm. The distance d2 includes, for example, a shortest distance between each corner of the internal electrode 51 at the end 51b and the external electrode 4 when viewed from the third direction D3. In the present embodiment, the distance d2 between the corner positioned closer to the side surface 2c among both the corners of the internal electrode 51 at the end 51b and the external electrode 4 and the distance d2 between the corner positioned closer to the side surface 2d among both the corners of the internal electrode 51 at the end 51b and the external electrode 4 are the same. The distance d2 between the corner positioned closer to the side surface 2c among both the corners of the internal electrode 51 at the end 51b and the external electrode 4 and the distance d2 between the corner positioned closer to the side surface 2d among both the corners of the internal electrode 51 at the end 51b and the external electrode 4 may be different from each other.

The internal electrode 52 includes a pair of ends 52a and 52b, a pair of ends 52c and 52d, a pair of end edges 52e and 52f, and a pair of surfaces 52g and 52h opposing each other.

The pair of ends 52a and 52b defines both ends of the internal electrode 52 in the first direction D1. The end 52a and the end 52b are positioned in the element body 2 and are not exposed to the outer surface of the element body 2. The end 52a and the end 52b are separated from each of the side surfaces 2a and 2b. The end 52a is positioned closer to the side surface 2a, and the end 52b is positioned closer to the side surface 2b. The end 52a opposes the end 51b of the internal electrode 51 exposed to the side surface 2a in the first direction D1. The end 52b opposes the end 51b of the internal electrode 51 exposed to the side surface 2b in the first direction D1.

The internal electrode 52 opposes the internal electrode 62 in the third direction D3 at the end 52a. The end 52a includes a region overlapping the internal electrode 62 when viewed from the third direction D3. In the present embodiment, the region of the end 52a extends from an end of the internal electrode 52 at the end 52a to an end of the internal electrode 62 at the end 62b when viewed from the third direction D3. That is, the end 52a includes the end of the internal electrode 52 and a region from the end of the internal electrode 52 to a predetermined length.

The internal electrode 52 opposes the internal electrode 61 in the third direction D3 at the end 52b. The end 52b includes a region overlapping the internal electrode 61 when viewed from the third direction D3. In the present embodiment, the region of the end 52b extends from the end of the internal electrode 52 at the end 52b to an end of the internal electrode 61 at an end 61a when viewed from the third direction D3. That is, the end 52b includes the distal end of the internal electrode 52 and a region from the distal end of the internal electrode 52 to a predetermined length.

The pair of ends 52c and 52d defines both ends of the internal electrode 52 in the second direction D2. The end 52c is exposed to the side surface 2c. The end 52c is connected to the external electrode 4 disposed on the side surface 2c. That is, the end 52c is connected to the corresponding external electrode of the pair of external electrodes 4. In the present embodiment, the end 52c is directly connected to the external electrode 4. The end 52c includes a connection end connected to the external electrode 4.

The end 52d is exposed to the side surface 2d. The end 52d is connected to the external electrode 4 disposed on the side surface 2d. That is, the end 52d is connected to the corresponding external electrode of the pair of external electrodes 4. In the present embodiment, the end 52d is directly connected to the external electrode 4. The end 52d includes a connection end connected to the external electrode 4.

The pair of surfaces 52g and 52h opposes each other in the third direction D3. In the present embodiment, the surface 52g is positioned closer to the side surface 2e, and the surface 52h is positioned closer to the side surface 2f. In the present embodiment, in order to realize a configuration in which each of the ends 52c and 52d is exposed to the corresponding side surface, the surface 52g and the surface 52h include one surface region R1 and a pair of surface regions R2. The surface region R1 has a rectangular shape including the second direction D2 as the long side direction and including the first direction D1 as the short side direction. The pair of surface regions R2 has the rectangular shape including the second direction D2 as the long side direction and including the first direction D1 as the short side direction, and extends in the second direction D2 from the corresponding short side of the surface region R1. The rectangular shape includes, for example, a shape in which each corner is chamfered or a shape in which each corner is rounded.

For example, a part of the surface region R1 is included in the end 52a, and another part positioned on the opposite side to the part of the surface region R1 in the first direction D1 is included in the end 52b. For example, a part of one surface region R2 of the pair of surface regions R2 is included in the end 52c, and a part of the other surface region R2 of the pair of surface regions R2 is included in the end 52d. Each of the end edges 52e and 52f is adjacent to each of the surface 52g and the surface 52h and couples the surface 52g and the surface 52h.

As illustrated in FIG. 3, the internal electrode 52 has a length L2. The length L2 includes, for example, a length of the internal electrode 52 in the first direction D1. The length L2 is, for example, larger than or equal to 0.3 mm and less than or equal to 0.8 mm. The length L2 in the present embodiment is 0.44 mm.

The internal electrode 52 has a width W2 at the ends 52a, 52b. That is, the ends 52a, 52b have the width W2. The width W2 includes, for example, a length of the internal electrode 52 in the second direction D2 at the ends 52a, 52b. The width W2 is, for example, larger than or equal to 0.1 mm and less than or equal to 0.6 mm. The width W2 in the present embodiment is 0.5 mm. In the present embodiment, the internal electrode 52 has the same width W2 at each of the ends 52a and 52b. The internal electrode 52 may have different widths W2 at each of the ends 52a and 52b.

In the present embodiment, the internal electrode 52 has the width W2 throughout its entirety. The internal electrode 52 only needs to have the width W2 at the ends 52a and 52b. For example, the internal electrode 52 may have a width different from the width W2 at a position other than the ends 52a and 52b.

In the internal electrode layer 5, a distance d3 between the internal electrode 51 and the internal electrode 52 is, for example, larger than or equal to 0.2 mm and less than or equal to 0.4 mm. The distance d3 in the present embodiment is 0.3 mm. The distance d3 includes, for example, a distance between the end of the internal electrode 51 at the end 51b and the end of the internal electrode 52 at the corresponding end in the first direction D1. In the present embodiment, the distance d3 between the internal electrode 51 exposed to the side surface 2a and the internal electrode 52 and the distance d3 between the internal electrode 51 exposed to the side surface 2b and the internal electrode 52 are the same. The distance d3 between the internal electrode 51 exposed to the side surface 2a and the internal electrode 52 and the distance d3 between the internal electrode 51 exposed to the side surface 2b and the internal electrode 52 may be different from each other.

The internal electrode 61 includes a pair of ends 61a and 61b, a pair of end edges 61c and 61d opposing each other, and a pair of surfaces 61 and 61f opposing each other. The pair of ends 61a and 61b defines both ends of the internal electrode 61 in the first direction D1. The end 61a and the end 61b are positioned in the element body 2 and are not exposed to the outer surface of the element body 2. The end 61a and the end 61b are separated from each of the side surfaces 2a and 2b. The end 61a is positioned closer to the side surface 2a and opposes the internal electrode 62 in the first direction D1. The end 61b is positioned on the opposite side of the end 61a.

The internal electrode 61 opposes the internal electrode 52 in the third direction D3 at the end 61a. In the present embodiment, the end 61a opposes the end 52b of the internal electrode 52 in the third direction D3. The end 61a includes a region overlapping the internal electrode 52 when viewed from the third direction D3. In the present embodiment, the end 61a includes a region overlapping the end 52b when viewed from the third direction D3. That is, the end 52b and the end 61a overlap each other when viewed from the third direction D3. In the present embodiment, the region of the end 61a extends from the end of the internal electrode 61 at the end 61a to the end of the internal electrode 52 at the end 52b when viewed from the third direction D3. That is, the end 61a includes the end of the internal electrode 61 and a region from the end of the internal electrode 61 to a predetermined length.

The internal electrode 61 opposes the internal electrode 51 exposed to the side surface 2b in the third direction D3 at the end 61b. In the present embodiment, the end 61b opposes the end 51b of the internal electrode 51 exposed to the side surface 2b in the third direction D3. The end 61b includes a region overlapping the internal electrode 51 exposed to the side surface 2b when viewed from the third direction D3. In the present embodiment, the end 61b includes a region overlapping the end 51b of the internal electrode 51 exposed to the side surface 2b when viewed from the third direction D3. That is, when viewed from the third direction D3, the end 51b of the internal electrode 51 exposed to the side surface 2b and the end 61b overlap each other. In the present embodiment, the region of the end 61b extends from the end of the internal electrode 61 at the end 61b to the end of the end 51b of the internal electrode 51 exposed to the side surface 2b when viewed from the third direction D3. That is, the end 61b includes the end of the internal electrode 61 and a region from the distal end of the internal electrode 61 to a predetermined length.

The pair of end edges 61c and 61d opposes each other in the second direction D2, and the pair of surfaces 61 and 61f opposes each other in the third direction D3. In the present embodiment, the end edge 61c is positioned closer to the side surface 2c, and the end edge 61d is positioned closer to the side surface 2d. In the present embodiment, the surface 61e is positioned closer to the side surface 2e, and the surface 61f is positioned closer to the side surface 2f. Each of the end edges 61c and 61d may include a surface. Each of the end edges 61c and 61d is adjacent to each of the surface 61 and the surface 61f and couples the surface 61 and the surface 61f.

The internal electrode 61 has a length L₃. The length L3 includes, for example, a length of the internal electrode 61 in the first direction D1. The length L3 is, for example, larger than or equal to 0.4 mm and less than or equal to 0.6 mm. The length L3 in the present embodiment is 0.5 mm.

The internal electrode 61 has a width W3 at the ends 61a, 61b. That is, the ends 61a, 61b have the width W3. The width W3 includes, for example, a length of the internal electrode 61 in the second direction D2 at the ends 61a, 61b. The width W3 is, for example, larger than or equal to 0.1 mm and less than or equal to 0.5 mm. The width W3 in the present embodiment is 0.2 mm. In the present embodiment, the internal electrode 61 has the same width W3 at each of the ends 61a and 61b. The internal electrode 61 may have a different widths W3 at each of the ends 61a and 61b.

In the present embodiment, the internal electrode 61 has the width W3 throughout its entirety. The internal electrode 61 only needs to have the width W3 at the ends 61a and 61b. For example, the internal electrode 61 may have a width different from the width W3 at a position other than the ends 61a and 61b.

The internal electrode 62 includes a pair of ends 62a and 62b, a pair of end edges 62c and 62d opposing each other, and a pair of surfaces 62e and 62f opposing each other. The pair of ends 62a and 62b defines both ends of the internal electrode 62 in the first direction D1. The end 62a and the end 62b are positioned in the element body 2 and are not exposed to the outer surface of the element body 2. The end 62a and the end 62b are separated from each of the side surfaces 2a and 2b. The end 62a is positioned closer to the side surface 2b. The end 62b is positioned on the opposite side of the end 61a and opposes the internal electrode 61 in the first direction D1.

The internal electrode 62 opposes the internal electrode 51 exposed to the side surface 2a in the third direction D3 at the end 62a. In the present embodiment, the end 62a opposes the end 51b of the internal electrode 51 exposed to the side surface 2a in the third direction D3. The end 62a includes a region overlapping the internal electrode 51 exposed to the side surface 2a when viewed from the third direction D3. In the present embodiment, the end 62a includes a region overlapping the end 51b of the internal electrode 51 exposed to the side surface 2a when viewed from the third direction D3. That is, when viewed from the third direction D3, the end 51b of the internal electrode 51 exposed to the side surface 2a and the end 62a overlap each other. In the present embodiment, the region of the end 62a extends from the end of the internal electrode 61 at the end 62a to the end of the end 51b of the internal electrode 51 exposed to the side surface 2a when viewed from the third direction D3. That is, the end 62a includes the end of the internal electrode 62 and a region from the end of the internal electrode 62 to a predetermined length.

The internal electrode 62 opposes the internal electrode 52 in the third direction D3 at the end 62b. In the present embodiment, the end 62b opposes the end 52a of the internal electrode 52 in the third direction D3. The end 62b includes a region overlapping the internal electrode 52 when viewed from the third direction D3. In the present embodiment, the end 62b includes a region overlapping the end 52a when viewed from the third direction D3. That is, the end 62b and the end 52a overlap each other when viewed from the third direction D3. In the present embodiment, the region of the end 62b extends from the end of the internal electrode 62 at the end 62b to the end of the internal electrode 52 at the end 52a when viewed from the third direction D3. That is, the end 62b includes the end of the internal electrode 62 and a region from the end of the internal electrode 62 to a predetermined length.

The pair of end edges 62c and 62d opposes each other in the second direction D2, and the pair of surfaces 62e and 62f opposes each other in the third direction D3. In the present embodiment, the end edge 62c is positioned closer to the side surface 2c, and the end edge 62d is positioned closer to the side surface 2d. In the present embodiment, the surface 62e is positioned closer to the side surface 2e, and the surface 62f is positioned closer to the side surface 2f. Each of the end edges 62c and 62d may include a surface. Each of the end edges 62c and 62d is adjacent to each of the surface 62e and the surface 62f and couples the surface 62e and the surface 62f.

The internal electrode 62 has a length L4. The length L4 includes, for example, a length of the internal electrode 62 in the first direction D1. The length L4 is, for example, larger than or equal to 0.4 mm and less than or equal to 0.6 mm. The length L4 in the present embodiment is 0.5 mm.

The internal electrode 62 has a width W4 at the ends 62a, 62b. That is, the end 62a, 62b have the width W4. The width W4 includes, for example, a length of the internal electrode 62 in the second direction D2 at the ends 62a, 62b. The width W4 is, for example, larger than or equal to 0.1 mm and less than or equal to 0.5 mm. The width W4 in the present embodiment is 0.2 mm. In the present embodiment, the internal electrode 62 has the same width W4 at each of the ends 62a and 62b.

The internal electrode 62 may have different widths W4 at each of the ends 62a and 62b.

In the present embodiment, the internal electrode 62 has the width W4 throughout its entirety. The internal electrode 62 only needs to have a width W4 at the ends 62a and 62b. For example, the internal electrode 62 may have a width different from the width W4 at a position other than the ends 62a and 62b.

As illustrated in FIGS. 2 and 4, the internal electrode 71 includes a pair of ends 71a and 71b, a pair of end edges 71c and 71d opposing each other, and a pair of surfaces 71and 71f opposing each other. FIG. 4 is a view of the internal electrodes 61 and 62 and the pair of internal electrodes 71 and the internal electrode 72 when viewed in a direction from the side surface 2f toward the side surface 2e in the third direction D3.

The pair of ends 71a and 71b defines both ends of the internal electrode 71 in the first direction D1. The end 71a is exposed to the side surface 2a. The end 71a is connected to the external electrode 3 disposed on the side surface 2a. That is, the end 71a is connected to the corresponding external electrode of the pair of external electrodes 3. In the present embodiment, the end 71a is directly connected to the external electrode 3. The end 71a includes a connection end connected to the external electrode 3. The end 71a may include an end surface.

The end 71b is positioned in the element body 2 and is not exposed to the outer surface of the element body 2. The end 71b is separated from each of the side surfaces 2a and 2b. The internal electrode 71 opposes the corresponding internal electrode of the internal electrodes 61 and 62 in the third direction D3 at the end 71b. In the present embodiment, the internal electrode 71 exposed to the side surface 2a opposes the internal electrode 61 in the third direction D3 at the end 71b, and the internal electrode 71 exposed to the side surface 2b opposes the internal electrode 62 in the third direction D3 at the end 71b. The end 71b includes a region overlapping the corresponding internal electrode when viewed from the third direction D3.

In the present embodiment, the end 71b of the internal electrode 71 exposed to the side surface 2a opposes the end 62a of the internal electrode 62 in the third direction D3. The end 71b of the internal electrode 71 exposed to the side surface 2a includes a region overlapping the internal electrode 62 when viewed from the third direction D3. In the present embodiment, the end 71b of the internal electrode 71 exposed to the side surface 2a includes a region overlapping the end 62a of the internal electrode 62 when viewed from the third direction D3. That is, when viewed from the third direction D3, the end 71b of the internal electrode 71 exposed to the side surface 2a and the end 62a overlap each other. In the present embodiment, the region of the end 71b of the internal electrode 71 exposed to the side surface 2a extends from an end of the internal electrode 71 to the end of the end 62a of the internal electrode 62 when viewed from the third direction D3.

In the present embodiment, the end 71b of the internal electrode 71 exposed to the side surface 2b opposes the end 61b of the internal electrode 61 in the third direction D3. The end 71b of the internal electrode 71 exposed to the side surface 2b includes a region overlapping the internal electrode 61 when viewed from the third direction D3. In the present embodiment, the end 71b of the internal electrode 71 exposed to the side surface 2b includes a region overlapping the end 61b of the internal electrode 61 when viewed from the third direction D3. That is, when viewed from the third direction D3, the end 71b of the internal electrode 71 exposed to the side surface 2b and the end 61b overlap each other. In the present embodiment, the region of the end 71b of the internal electrode 71 exposed to the side surface 2b extends from an end of the internal electrode 71 to the end at the end 61b of the internal electrode 61 when viewed from the third direction D3.

That is, the end 71b includes the end of the internal electrode 71 and a region from the end of the internal electrode 71 to a predetermined length. Therefore, the end 71b has the predetermined length in the first direction D1. The end 71b is buried in the element body 2 and is in contact with only the element body 2.

The pair of end edges 71c and 71d opposes each other in the second direction D2, and the pair of surfaces 71e and 71f opposes each other in the third direction D3. In the present embodiment, the end edge 71c is positioned closer to the side surface 2c, and the end edge 71d is positioned closer to the side surface 2d. In the present embodiment, the surface 71is positioned closer to the side surface 2e, and the surface 71f is positioned closer to the side surface 2f. Each of the end edges 71c and 71d may include a surface. Each of the end edges 71c and 71d is adjacent to each of the surface 71and the surface 71f and couples the surface 71and the surface 71f.

As illustrated in FIG. 4, the internal electrode 71 has a length L5. The length L5 includes, for example, a length of the internal electrode 71 in the first direction D1. The length L5 is, for example, larger than or equal to 0.25 mm and less than or equal to 0.5 mm. In the present embodiment, the length L5 is 0.405 mm. In the present embodiment, the pair of internal electrodes 71 has the same length L5. The pair of internal electrodes 71 may have different lengths L5 from each other.

The internal electrode 71 has a width W5 at the end 71b. That is, the end 71b has the width W5. The width W5 includes, for example, a length of the internal electrode 71 in the second direction D2 at the end 71b. The width W5 is, for example, larger than or equal to 0.1 mm and less than or equal to 0.6 mm. In the present embodiment, the width W5 is 0.5 mm.

In the present embodiment, the internal electrode 71 has the width W5 throughout its entirety. The internal electrode 71 only needs to have the width W5 at the end 71b. For example, the internal electrode 71 may have a width different from the width W5 at a position other than the end 71b. In the present embodiment, the pair of internal electrodes 71 has the same width W5 at each end 71b. The pair of internal electrodes 71 may have different widths W5 at each end 71b.

In the internal electrode layer 7, a distance d4 between the internal electrode 71 and the outer surface of the element body 2 is, for example, larger than or equal to 0.1 mm and less than or equal to 0.4 mm. In the present embodiment, the distance d4 is 0.2 mm. The distance d4 includes, for example, a distance between the pair of end edges 71c and 71d and the corresponding side surface of the side surfaces 2c and 2d in the second direction D2. In the present embodiment, the distance d4 between the internal electrode 71 exposed to the side surface 2a and the outer surface of the element body 2 and the distance d4 between the internal electrode 71 exposed to the side surface 2b and the outer surface of the element body 2 are the same. The distance d4 between the internal electrode 71 exposed to the side surface 2a and the outer surface of the element body 2 and the distance d4 between the internal electrode 71 exposed to the side surface 2b and the outer surface of the element body 2 may be different from each other.

In the internal electrode layer 7, a distance d5 between the internal electrode 71 and the external electrode 4 is, for example, larger than or equal to 0.21 mm and less than or equal to 0.57 mm. In the present embodiment, the distance d5 is 0.36 mm. The distance d5 includes, for example, the shortest distance between each corner of the internal electrode 71 at the end 71b and the external electrode 4 when viewed from the third direction D3. In the present embodiment, the distance d5 between a corner positioned closer to the side surface 2c among both corners of the internal electrode 71 at the end 71b and the external electrode 4 and the distance d5 between a corner positioned closer to the side surface 2d among both corners of the internal electrode 71 at the end 71b and the external electrode 4 are the same. The distance d5 between the corner positioned closer to the side surface 2c among both corners of the internal electrode 71 at the end 71b and the external electrode 4 and the distance d5 between the corner positioned closer to the side surface 2d among both corners of the internal electrode 71 at the end 71b and the external electrode 4 may be different from each other.

The internal electrode 72 includes a pair of ends 72a and 72b, a pair of ends 72c and 72d, a pair of end edges 72e and 72f, and a pair of surfaces 72g and 72h opposing each other.

The pair of ends 72a and 72b defines both ends of the internal electrode 72 in the first direction D1. The end 72a and the end 72b are positioned in the element body 2 and are not exposed to the outer surface of the element body 2. The end 72a and the end 72b are separated from each of the side surfaces 2a and 2b. The end 72a is positioned closer to the side surface 2a, and the end 72b is positioned closer to the side surface 2b. The end 72a opposes the end 71b of the internal electrode 71 exposed to the side surface 2a in the first direction D1. The end 72b opposes the end 71b of the internal electrode 71 exposed to the side surface 2b in the first direction D1.

The internal electrode 72 opposes the internal electrode 62 in the third direction D3 at the end 72a. In the present embodiment, the end 72a opposes the end 62b of the internal electrode 62 in the third direction D3. The end 72a includes a region overlapping the internal electrode 62 when viewed from the third direction D3. In the present embodiment, the end 72a includes a region overlapping the end 62b when viewed from the third direction D3. That is, the end 72b and the end 62b overlap each other when viewed from the third direction D3. In the present embodiment, the region of the end 72a extends from an end of the internal electrode 72 at the end 72a to the end of the internal electrode 62 at the end 62b when viewed from the third direction D3. That is, the end 72a includes the end of the internal electrode 72 and a region from the end of the internal electrode 72 to a predetermined length. Therefore, the end 72a has the predetermined length in the first direction D1. The end 72a is buried in the element body 2 and is in contact with only the element body 2.

The internal electrode 72 opposes the internal electrode 61 in the third direction D3 at the end 72b. In the present embodiment, the end 72b opposes the end 61a of the internal electrode 61 in the third direction D3. The end 72b includes a region overlapping the internal electrode 61 when viewed from the third direction D3. In the present embodiment, the end 72b includes a region overlapping the end 61a when viewed from the third direction D3. That is, the end 72a and the end 61a overlap each other when viewed from the third direction D3. In the present embodiment, the region of the end 72b extends from the end of the internal electrode 72 at the end 72b to the end of the internal electrode 61 at the end 61a when viewed from the third direction D3. That is, the end 72b includes the end of the internal electrode 72 and a region from the end of the internal electrode 72 to a predetermined length. Therefore, the end 72b has the predetermined length in the first direction D1. The end 72b is buried in the element body 2 and is in contact with only the element body 2.

The pair of ends 72c and 72d defines both ends of the internal electrode 72 in the second direction D2. The end 72c is exposed to the side surface 2c. The end 72c is connected to the external electrode 4 disposed on the side surface 2c. That is, the end 72c is connected to the corresponding external electrode of the pair of external electrodes 4. In the present embodiment, the end 72c is directly connected to the external electrode 4. The end 72c includes a connection end connected to the external electrode 4. The end 72d is exposed to the side surface 2d. The end 72d is connected to the external electrode 4 disposed on the side surface 2d. That is, the end 72d is connected to the corresponding external electrode of the pair of external electrodes 4. In the present embodiment, the end 72d is directly connected to the external electrode 4. The end 72d includes a connection end connected to the external electrode 4.

The pair of surfaces 72g and 72h opposes each other in the third direction D3. In the present embodiment, the surface 72g is positioned closer to the side surface 2e, and the surface 72h is positioned closer to the side surface 2d. In the present embodiment, in order to realize a configuration in which the ends 72c and 72d are exposed to the corresponding side surface of the side surfaces 2c and 2d, the surface 72g and the surface 72h include a surface region R3 and a pair of surface regions R4. The surface region R3 has a rectangular shape including the second direction D2 as the long side direction and including the first direction D1 as the short side direction. The pair of surface regions R4 has a rectangular shape including the second direction D2 as the long side direction and including the first direction D1 as the short side direction, and extends in the second direction D2 from the corresponding short side of the surface region R1.

For example, a part of the surface region R3 is included in the end 72a, and another part positioned on the opposite side to the part of the surface region R3 in the first direction D1 is included in the end 72b. For example, a part of one surface region R2 of the pair of surface regions R4 is included in the end 72c, and a part of the other surface region R4 of the pair of surface regions R4 is included in the end 72d. Each of the end edges 72e and 72f is adjacent to each of the surface 72g and the surface 72h and couples the surface 72g and the surface 72h.

As illustrated in FIG. 4, the internal electrode 72 has a length L6. The length L6 includes, for example, a length of the internal electrode 72 in the first direction D1. The length L6 is, for example, larger than or equal to 0.3 mm and less than or equal to 0.8 mm. The length L6 in the present embodiment is 0.44 mm.

The internal electrode 72 has the width W6 at the ends 72a, 72b. That is, the ends 72a, 72b have the width W6. The width W6 includes, for example, a length of the internal electrode 72 in the second direction D2 at the ends 72a, 72b. The width W6 is, for example, larger than or equal to 0.1 mm and less than or equal to 0.6 mm. The width W6 in the present embodiment is 0.5 mm. In the present embodiment, the internal electrode 72 has the same width W6 at each of the ends 72a and 72b. The internal electrode 72 may have different widths W6 at each of the ends 72a and 72b.

In the present embodiment, the internal electrode 72 has the width W6 throughout its entirety. The internal electrode 72 only needs to have the width W6 at the ends 72a and 72b. For example, the internal electrode 72 may have a width different from the width W6 at a position other than the ends 72a and 72b.

In the internal electrode layer 7, a distance d6 between the internal electrode 71 and the internal electrode 72 is, for example, larger than or equal to 0.2 mm and less than or equal to 0.4 mm. The distance d6 in the present embodiment is 0.3 mm. The distance d6 includes, for example, a distance between the end of the internal electrode 71 at the end 71b and the end of the internal electrode 72 at the corresponding end in the first direction D1. In the present embodiment, the distance d6 between the internal electrode 71 exposed to the side surface 2a and the internal electrode 72 and the distance d6 between the internal electrode 71 exposed to the side surface 2b and the internal electrode 72 are the same. The distance d6 between the internal electrode 71 exposed to the side surface 2a and the internal electrode 72 and the distance d6 between the internal electrode 71 exposed to the side surface 2b and the internal electrode 72 may be different from each other.

In the chip varistor 1, a varistor is formed between the internal electrode 61 and the internal electrodes 51 and 52. In the present embodiment, the end 61b, the end 51b opposing the end 61b, and a region between the end 61b and the end 51b of the element body 2 function as a varistor between the internal electrode 61 and the internal electrode 51. The end 61a, the end 52b, and a region between the end 61a and the end 52b of the element body 2 function as a varistor between the internal electrode 61 and the internal electrode 52. These varistors are connected in series via the internal electrode 61. That is, the internal electrode 61 is disposed to form a plurality of varistors connected in series between the internal electrode 51 exposed to the side surface 2b and the internal electrode 52.

In the chip varistor 1, the varistor is formed between the internal electrode 62 and the internal electrodes 51 and 52. In the present embodiment, the end 62a, the end 51b opposing the end 62a, and a region between the end 62a and the end 51b of the element body 2 function as a varistor between the internal electrode 62 and the internal electrode 51. The end 62b, the end 52a, and the region between the end 62b and the end 52a of the element body 2 function as a varistor between the internal electrode 62 and the internal electrode 52. These varistors are connected in series via the internal electrode 62. That is, the internal electrode 62 is disposed to form a plurality of varistors connected in series between the internal electrode 51 exposed to the side surface 2a and the internal electrode 52.

In the chip varistor 1, the varistor is formed between the internal electrode 61 and the internal electrodes 71 and 72. In the present embodiment, the end 61b, the end 71b opposing the end 61b, and a region between the end 61b and the end 71b of the element body 2 function as a varistor between the internal electrode 61 and the internal electrode 71. The end 61a, the end 72b, and a region between the end 61a and the end 72b of the element body 2 function as a varistor between the internal electrode 61 and the internal electrode 72. These varistors are connected in series via the internal electrode 61. That is, the internal electrode 61 is disposed to form a plurality of varistors connected in series between the internal electrode 71 exposed to the side surface 2b and the internal electrode 72.

In the chip varistor 1, the varistor is formed between the internal electrode 62 and the internal electrodes 71 and 72. In the present embodiment, the end 62a, the end 71b opposing the end 62a, and a region between the end 62a and the end 71b of the element body 2 function as a varistor between the internal electrode 62 and the internal electrode 71. The end 62b, the end 72a, and a region between the end 62b and the end 72a of the element body 2 function as a varistor between the internal electrode 62 and the internal electrode 72. These varistors are connected in series via the internal electrode 62. That is, the internal electrode 62 is disposed to form a plurality of varistors connected in series between the internal electrode 71 exposed to the side surface 2a and the internal electrode 72.

A distance d7 between the internal electrode layer 5 and the internal electrode layer 6 illustrated in FIG. 2 is, for example, larger than or equal to 0.06 mm and less than or equal to 0.18 mm. A distance d8 between the internal electrode layer 6 and the internal electrode layer 7 is, for example, larger than or equal to 0.06 mm and less than or equal to 0.18 mm. The distance d7 and the distance d8 may be larger than or equal to 0.09 mm and less than or equal to 0.12 mm. The distance d7 and the distance d8 in the present embodiment are 0.09 mm. That is, in the present embodiment, the distance d7 and the distance d8 are the same.

The distance d7 includes, for example, a shortest distance between the surface 51f and the surface 62e opposing each other in the third direction D3. The distance d8 includes, for example, a shortest distance between the surface 62f and the surface 71e opposing each other in the third direction D3. The distance d7 may include a shortest distance between the surface 52h and the surface 62e opposing each other in the third direction D3, and the distance d8 may include a shortest distance between the surface 62f and the surface 72g opposing each other in the third direction D3.

For example, the distance d7 and the distance d8 are different from the distance d2 between the internal electrode 51 and the external electrode 4 and the distance d5 between the internal electrode 71 and the external electrode 4. In the present embodiment, the distance d2 and the distance d5 are larger than the distance d7 and the distance d8. The distance d2 and the distance d5 are, for example, twice or more of the distance d7 and the distance d8.

For example, the distance d7 and the distance d8 are different from the distance d3 between the internal electrode 51 and the internal electrode 52 and the distance d6 between the internal electrode 71 and the internal electrode 72. In the present embodiment, the distance d3 and the distance d6 are larger than the distance d7 and the distance d8. The distance d3 and the distance d6 are, for example, twice or more of the distance d7 and the distance d8.

For example, a length of the end 61a in the first direction D1 and the length L2 of the internal electrode 52 are different from each other, and a length of the end 61b in the first direction D1 and the length L1 of the internal electrode 51 exposed to the side surface 2b are different from each other. In the present embodiment, the length of the end 61a in the first direction D1 is smaller than the length L2, and the length of the end 61b in the first direction D1 is smaller than the length L1 of the internal electrode 51 exposed to the side surface 2b.

For example, a length of the end 62a in the first direction D1 and the length L1 of the internal electrode 51 exposed to the side surface 2a are different from each other, and a length of the end 62b in the first direction D1 and the length L2 of the internal electrode 52 are different from each other. In the present embodiment, the length of the end 62a in the first direction D1 is smaller than the length L1 of the internal electrode 51 exposed to the side surface 2a, and the length of the end 61b in the first direction D1 is smaller than the length L2.

For example, the length of the end 61a in the first direction D1 and the length L6 of the internal electrode 72 are different from each other, and the length of the end 61b in the first direction D1 and the length L5 of the internal electrode 71 exposed to the side surface 2b are different from each other. In the present embodiment, the length of the end 61a in the first direction D1 is smaller than the length L6, and the length of the end 61b in the first direction D1 is smaller than the length L5 of the internal electrode 71 exposed to the side surface 2b.

For example, the length of the end 62a in the first direction D1 and the length L5 of the internal electrode 71 exposed to the side surface 2a are different from each other, and the length of the end 62b in the first direction D1 and the length L6 of the internal electrode 72 are different from each other. In the present embodiment, the length of the end 62a in the first direction D1 is smaller than the length L5 of the internal electrode 71 exposed to the side surface 2a, and the length of the end 61b in the first direction D1 is smaller than the length L6.

The width W1 of the internal electrode 51 exposed to the side surface 2a and the width W4 at the end 62a are different from each other. In the present embodiment, the width W1 of the internal electrode 51 exposed to the side surface 2a is larger than the width W4 at the end 62a. In the present embodiment, when viewed from the third direction D3, the pair of end edges 51c and 51d at the end 51b of the internal electrode 51 exposed to the side surface 2a is positioned on the outer side of the pair of end edges 62c and 62d at the end 62a. A distance d9 includes a distance between the end edge 51c and the end edge 62c in the second direction D2 and a distance between the end edge 51d and the end edge 62d in the second direction D2. The distance d9 is, for example, larger than or equal to 0.05 mm and less than or equal to 0.20 mm. The distance d9 may be larger than or equal to 0.10 mm and less than or equal to 0.15 mm. The distance d9 in the present embodiment is 0.15 mm. That is, in the present embodiment, the distance d9 between the end edge 51c and the end edge 62c in the second direction D2 and the distance d9 between the end edge 51d and the end edge 62d in the second direction D2 are the same. The distance d9 between the end edge 51c and the end edge 62c in the second direction D2 and the distance d9 between the end edge 51d and the end edge 62d in the second direction D2 may be different from each other.

The width W1 of the internal electrode 51 exposed to the side surface 2b and the width W3 at the end 61b are different from each other. In the present embodiment, the width W1 of the internal electrode 51 exposed to the side surface 2b is larger than the width W3 at the end 61b. In the present embodiment, when viewed from the third direction D3, the pair of end edges 51c and 51d at the end 51b of the internal electrode 51 exposed to the side surface 2b is positioned on the outer side of the pair of end edges 61c and 61d at the end 61b. A distance d10 includes a distance between the end edge 51c and the end edge 61c in the second direction D2 and a distance between the end edge 51d and the end edge 61d in the second direction D2. The distance d10 is, for example, larger than or equal to 0.05 mm and less than or equal to 0.20 mm. The distance d10 may be larger than or equal to 0.10 mm and less than or equal to 0.15 mm. Each distance d10 in the present embodiment is 0.15 mm. That is, in the present embodiment, the distance d10 between the end edge 51c and the end edge 61c in the second direction D2 and the distance d10 between the end edge 51d and the end edge 61d in the second direction D2 are the same. The distance d10 between the end edge 51c and the end edge 61c in the second direction D2 and the distance d10 between the end edge 51d and the end edge 61d in the second direction D2 may be different from each other.

For example, the lengths L1 of the pair of internal electrodes 51, the length L3 of the internal electrode 61, and the length L4 of the internal electrode 62 are different from each other. In the present embodiment, the length L3 and the length L4 are larger than the lengths L1. For example, the width W3 of the internal electrode 61 and the width W4 of the internal electrode 62, and the distances d1 between the pair of internal electrodes 51 and the outer surface of the element body 2 are different from each other. In the present embodiment, the width W3 and the width W4 are larger than the distances d1.

The width W2 at the end 52a and the width W4 at the end 62b are different from each other. In the present embodiment, the width W2 at the end 52a is larger than the width W4 at the end 62b. In the present embodiment, when viewed from the third direction D3, the pair of end edges 52e and 52f at the end 52a is positioned on the outer side of the pair of end edges 62c and 62d at the end 62b. A distance d11 includes a distance between the end edge 52e and the end edge 62c in the second direction D2 and a distance between the end edge 52f and the end edge 62d in the second direction D2. The distance d11 is, for example, larger than or equal to 0.05 mm and less than or equal to 0.20 mm. The distance d11 may be larger than or equal to 0.10 mm and less than or equal to 0.15 mm. Each distance d11 in the present embodiment is 0.15 mm. That is, in the present embodiment, the distance d11 between the end edge 52e and the end edge 62c in the second direction D2 and the distance d11 between the end edge 52f and the end edge 62d in the second direction D2 are the same. The distance d11 between the end edge 52e and the end edge 62c in the second direction D2 and the distance d11 between the end edge 52f and the end edge 62d in the second direction D2 may be different from each other.

The width W2 at the end 52b and the width W4 at the end 61a are different from each other. In the present embodiment, the width W2 at the end 52b is larger than the width W4 at the end 61a. In the present embodiment, when viewed from the third direction D3, the pair of end edges 52e and 52f at the end 52b is positioned on the outer side of the pair of end edges 62c and 62d at the end 62a. A distance d12 includes a distance between the end edge 52e and the end edge 61c in the second direction D2 and a distance between the end edge 52f and the end edge 61d in the second direction D2. The distance d12 is, for example, larger than or equal to 0.05 mm and less than or equal to 0.20 mm. The distance d12 may be larger than or equal to 0.10 mm and less than or equal to 0.15 mm. Each distance d12 in the present embodiment is 0.15 mm. That is, in the present embodiment, the distance d12 between the end edge 52e and the end edge 61c in the second direction D2 and the distance d12 between the end edge 52f and the end edge 61d in the second direction D2 are the same. The distance d12 between the end edge 52e and the end edge 61c in the second direction D2 and the distance d12 between the end edge 52f and the end edge 61d in the second direction D2 may be different from each other.

The width W5 of the internal electrode 71 exposed to the side surface 2a and the width W4 at the end 62a are different from each other. In the present embodiment, the width W5 of the internal electrode 71 exposed to the side surface 2a is larger than the width W4 at the end 62a. In the present embodiment, when viewed from the third direction D3, the pair of end edges 71c and 71d at the end 71b of the internal electrode 71 exposed to the side surface 2a is positioned on the outer side of the pair of end edges 62c and 62d at the end 62a. A distance d13 includes a distance between the end edge 71c and the end edge 62c in the second direction D2 and a distance between the end edge 71d and the end edge 62d in the second direction D2. The distance d13 is, for example, larger than or equal to 0.05 mm and less than or equal to 0.20 mm. The distance d13 may be larger than or equal to 0.10 mm and less than or equal to 0.15 mm. Each distance d13 in the present embodiment is 0.15 mm. That is, in the present embodiment, the distance d13 between the end edge 71c and the end edge 62c in the second direction D2 and the distance d13 between the end edge 71d and the end edge 62d in the second direction D2 are the same. The distance d13 between the end edge 71c and the end edge 62c in the second direction D2 and the distance d13 between the end edge 71d and the end edge 62d in the second direction D2 may be different from each other.

The width W5 of the internal electrode 71 exposed to the side surface 2b and the width W3 at the end 61b are different from each other. In the present embodiment, the width W5 of the internal electrode 71 exposed to the side surface 2b is larger than the width W3 at the end 61b. In the present embodiment, when viewed from the third direction D3, the pair of end edges 71c and 71d at the end 71b of the internal electrode 71 exposed to the side surface 2b is positioned on the outer side of the pair of end edges 61c and 61d at the end 61b. A distance d14 includes a distance between the end edge 71c and the end edge 61c in the second direction D2 and a distance between the end edge 71d and the end edge 61d in the second direction D2. The Distance d14 is, for example, larger than or equal to 0.05 mm and less than or equal to 0.20 mm. The distance d14 may be larger than or equal to 0.10 mm and less than or equal to 0.15 mm. Each distance d14 in the present embodiment is 0.15 mm. That is, in the present embodiment, the distance d14 between the end edge 71c and the end edge 61c in the second direction D2 and the distance d14 between the end edge 71d and the end edge 61d in the second direction D2 are the same. The distance d14 between the end edge 71c and the end edge 61c in the second direction D2 and the distance d14 between the end edge 71d and the end edge 61d in the second direction D2 may be different from each other.

For example, the length L5 of the pair of internal electrodes 71, the length L3 of the internal electrode 61, and the length L4 of the internal electrode 62 are different from each other. In the present embodiment, the length L3 and the length L4 are larger than the length L5. For example, the width W3 of the internal electrode 61 and the width W4 of the internal electrode 62, and the distances d4 between the internal electrodes 71 and the outer surface of the element body 2 are different from each other. In the present embodiment, the width W3 and the width W4 are larger than the distances d4.

The width W6 at the end 72a and the width W4 at the end 62b are different from each other. In the present embodiment, the width W6 at the end 72a is larger than the width W4 at the end 62b. In the present embodiment, when viewed from the third direction D3, the pair of end edges 72e and 72f at the end 72a is positioned on the outer side of the pair of end edges 62c and 62d at the end 62b. A distance d15 includes a distance between the end edge 72e and the end edge 62c in the second direction D2 and a distance between the end edge 72f and the end edge 62d in the second direction D2. The Distance d15 is, for example, larger than or equal to 0.05 mm and less than or equal to 0.20 mm. The distance d15 may be larger than or equal to 0.10 mm and less than or equal to 0.15 mm. Each distance d15 in the present embodiment is 0.15 mm. That is, in the present embodiment, the distance d15 between the end edge 72e and the end edge 62c in the second direction D2 and the distance d11 between the end edge 72f and the end edge 62d in the second direction D2 are the same. The distance d15 between the end edge 72e and the end edge 62c in the second direction D2 and the distance d15 between the end edge 72f and the end edge 62d in the second direction D2 may be different from each other.

The width W6 at the end 72b and the width W3 at the end 61a are different from each other. In the present embodiment, the width W6 at the end 72b is larger than the width W3 at the end 61a. In the present embodiment, when viewed from the third direction D3, the pair of end edges 72e and 72f at the end 72b is positioned on the outer side of the pair of end edges 62c and 62d at the end 61a. A distance d16 include a distance between the end edge 72e and the end edge 62c in the second direction D2 and a distance between the end edge 72f and the end edge 62d in the second direction D2. The distance d16 is, for example, larger than or equal to 0.05 mm and less than or equal to 0.20 mm. The distance d16 may be larger than or equal to 0.10 mm and less than or equal to 0.15 mm. Each distance d16 in the present embodiment is 0.15 mm. That is, in the present embodiment, the distance d16 between the end edge 72e and the end edge 62c in the second direction D2 and the distance d16 between the end edge 72f and the end edge 62d in the second direction D2 are the same. The distance d16 between the end edge 72e and the end edge 62c in the second direction D2 and the distance d16 between the end edge 72f and the end edge 62d in the second direction D2 may be different from each other.

For example, when the side surface 2a includes the first side surface, the side surface 2b includes the second side surface. For example, when the internal electrode layer 5 includes a first internal electrode layer, the internal electrode layer 6 includes a second internal electrode layer, and the internal electrode layer 7 includes a third internal electrode layer. For example, when the internal electrode 51 exposed to the side surface 2a includes a first internal electrode and the internal electrode 51 exposed to the side surface 2b includes a second internal electrode, the internal electrode 52 includes a third internal electrode, the internal electrode 62 includes a fourth internal electrode, the internal electrode 61 includes a fifth internal electrode, the internal electrode 71 exposed to the side surface 2a includes a sixth internal electrode, the internal electrode 71 exposed to the side surface 2b includes a seventh internal electrode, and the internal electrode 72 includes an eighth internal electrode.

As described above, in the chip varistor 1, among the plurality of internal electrodes 51, 52, 61, 62, 71, and 72, the internal electrodes opposing each other include the ends opposing each other and having the different widths.

In the present embodiment, the width W1 of the internal electrode 51 exposed to the side surface 2a is different from the width W4 of the internal electrode 62 at the end 62a. Therefore, regardless of a relative position of the internal electrode 51 exposed to the side surface 2a and the internal electrode 62 in the second direction D2, area of the region where the end 51b and the end 62a opposing each other overlap each other tends not to change. As a result, regardless of the relative position of the internal electrode 51 exposed to the side surface 2a and the internal electrode 62 in the second direction D2, the chip varistor 1 can obtain desired characteristics.

In the present embodiment, the width W1 of the internal electrode 51 exposed to the side surface 2b is different from the width W3 of the internal electrode 61 at the end 61b. Therefore, regardless of a relative position of the of the internal electrode 51 exposed to the side surface 2b and the internal electrode 61 in the second direction D2, area of the region where the end 51b and the end 61b opposing each other overlap each other tends not to change. As a result, regardless of the relative position of the of the internal electrode 51 exposed to the side surface 2b and the internal electrode 61 in the second direction D2, the chip varistor 1 can obtain the desired characteristics.

In the present embodiment, the width W2 of the internal electrode 52 at the end 52a is different from the width W4 of the internal electrode 62 at the end 62b. Therefore, regardless of a relative position of the internal electrode 52 and the internal electrode 62 in the second direction D2, area of the region where the end 52a and the end 62b opposing each other overlap tends not to change. As a result, regardless od the relative position of the internal electrode 52 and the internal electrode 62 in the second direction D2, the chip varistor 1 can obtain the desired characteristics.

In the present embodiment, the width W2 of the internal electrode 52 at the end 52b is different from the width W3 of the internal electrode 61 at the end 61a. Therefore, regardless of a relative position of the internal electrode 52 and the internal electrode 61 in the second direction D2, area of the region where the end 52b and the end 61a opposing each other overlap tends not to change. As a result, regardless of the relative position of the internal electrodes 52 and 61 opposing each other in the second direction D2, the chip varistor 1 can obtain the desired characteristics.

In the present embodiment, the width W5 of the internal electrode 71 exposed to the side surface 2a is different from the width W4 of the internal electrode 62 at the end 62a. Therefore, regardless of a relative position of the internal electrode 71 exposed to the side surface 2a and the internal electrode 62 in the second direction D2, area of the region where the end 71b and the end 62a opposing each other overlap each other tends not to change. As a result, regardless of the relative position of the internal electrodes 71 and 62 opposing each other in the second direction D2, the chip varistor 1 can obtain the desired characteristics.

In the present embodiment, the width W5 of the internal electrode 71 exposed to the side surface 2b is different from the width W3 of the internal electrode 61 at the end 61b. Therefore, regardless of a relative position of the internal electrode 71 exposed to the side surface 2b and the internal electrode 61 in the second direction D2, area of the region where the end 71b and the end 61b opposing each other overlap each other tends not to change. As a result, regardless of the relative position of the internal electrode 71 exposed to the side surface 2b and the internal electrode 61 in the second direction D2, the chip varistor 1 can obtain the desired characteristics.

In the present embodiment, the width W6 of the internal electrode 72 at the end 72a is different from the width W4 of the internal electrode 62 at the end 62b. Therefore, regardless of a relative position of the internal electrode 72 and the internal electrode 62 in the second direction D2, area of the region where the end 72a and the end 62b opposing each other overlap tends not to change. As a result, regardless of the relative position of the internal electrodes 72 and 62 opposing each other in the second direction D2, the chip varistor 1 can obtain the desired characteristics.

In the present embodiment, the width W6 of the internal electrode 72 at the end 72b is different from the width W3 of the internal electrode 61 at the end 61a. Therefore, regardless of a relative position of the internal electrode 72 and the internal electrode 61 in the second direction D2, area of the region where the end 72b and the end 61a opposing each other overlap tends not to change. As a result, regardless of the relative position of the internal electrodes 72 and 61 opposing each other in the second direction D2, the chip varistor 1 can obtain the desired characteristics.

In the chip varistor 1, the width W3 is smaller than corresponding widths W1 and W2, and the width W4 is smaller than corresponding widths W1 and W2. In a configuration in which the width W3 is smaller than the corresponding widths W1 and W2, discharge tends not to occur between the internal electrode 61 and the external electrode 4 and between the internal electrode 61 and the ends 52c and 52d of the internal electrode 52. In a configuration in which the width W4 is smaller than the corresponding widths W1 and W2, discharge tends not to occur between the internal electrode 62 and the external electrode 4 and between the internal electrode 62 and the ends 52c and 52d of the internal electrode 52. As a result, the chip varistor 1 can prevent deterioration of characteristics.

In the chip varistor 1, the width W3 is smaller than corresponding widths W5 and W6, and the width W4 is smaller than corresponding widths W5 and W6. In a configuration in which the width W3 is smaller than the corresponding widths W5 and W6, discharge tends not to occur between the internal electrode 61 and the external electrode 4 and between the internal electrode 61 and the ends 72c and 72d of the internal electrode 72. In a configuration in which the width W4 is smaller than the corresponding widths W5 and W6, discharge tends not to occur between the internal electrode 62 and the external electrode 4 and between the internal electrode 62 and the ends 72c and 72d of the internal electrode 72. As a result, the chip varistor 1 can further prevent the deterioration of the characteristics.

In the chip varistor 1, the width W1 of the pair of internal electrodes 51 and the width W2 of the internal electrodes 52 are the same. The chip varistor 1 can easily form the pair of internal electrodes 51 and the internal electrode 52. In the chip varistor 1, the width W5 of the pair of internal electrodes 71 and the width W6 of the internal electrodes 72 are the same. The chip varistor 1 can easily form the pair of internal electrodes 71 and the internal electrode 72.

The chip varistor 1 includes the plurality of external electrodes 3 and 4 connected to corresponding internal electrodes among the pair of internal electrodes 51 and the internal electrodes 52. The chip varistor 1 can obtain the desired characteristics even in a configuration in which the chip varistor includes the three-terminal chip varistor.

In the chip varistor 1, the plurality of internal electrodes include the internal electrode layers 5, 6, and 7. The chip varistor 1 improve resistance to electrostatic discharge as compared with a configuration in which the plurality of internal electrodes include only the internal electrode layers 5 and 6.

In the chip varistor 1, the length of the end 61a in the first direction D1 is smaller than the length L2, and the length of the end 61b in the first direction D1 is smaller than the length L1 of the internal electrode 51 exposed to the side surface 2b. Therefore, regardless of the relative positions of the internal electrode 61, and the internal electrode 51 exposed to the side surface 2b and the internal electrode 52 in the first direction D1, the sum of the area of the region where the end 61b and the end 51b opposing each other overlap each other and the area of the region where the end 61a and the end 52b opposing each other overlap each other tends not to change. As a result, regardless of the relative positions of the internal electrode 61 and the internal electrode 51 exposed to the side surface 2b and the internal electrode 52 opposing each other in the first direction D1, the chip varistor 1 can obtain the desired characteristics.

In the chip varistor 1, the length of the end 62a in the first direction D1 is smaller than the length L1 of the internal electrode 51 exposed to the side surface 2a, and the length of the end 61b in the first direction D1 is smaller than the length L2. Therefore, regardless of the relative positions of the internal electrode 62, and the internal electrode 51 exposed to the side surface 2a and the internal electrode 52 in the first direction D1, the sum of the area of the region where the end 62a and the end 51b opposing each other overlap each other and the area of the region where the end 62b and the end 52a opposing each other overlap each other tends not to change. As a result, regardless of the relative positions of the internal electrode 62 and the internal electrode 51 exposed to the side surface 2a and the internal electrode 52 opposing each other in the first direction D1, the chip varistor 1 can obtain the desired characteristics.

In the chip varistor 1, the length of the end 61a in the first direction D1 is smaller than the length L6, and the length of the end 61b in the first direction D1 is smaller than the length L5 of the internal electrode 71 exposed to the side surface 2b. Therefore, regardless of the relative positions of the internal electrode 61, and the internal electrode 71 exposed to the side surface 2b and the internal electrode 72 in the first direction D1, the sum of the area of the region where the end 61b and the end 71b opposing each other overlap each other and the area of the region where the end 61a and the end 72b opposing each other overlap each other tends not to change. As a result, regardless of the relative positions of the internal electrode 61 and the internal electrode 71 exposed to the side surface 2b and the internal electrode 72 opposing each other in the first direction D1, the chip varistor 1 can obtain the desired characteristics.

In the chip varistor 1, the length of the end 62a in the first direction D1 is smaller than the length L5 of the internal electrode 71 exposed to the side surface 2b, and the length of the end 62b in the first direction D1 is smaller than the length L6. Therefore, regardless of the relative positions of the internal electrode 62, and the internal electrode 71 exposed to the side surface 2a and the internal electrode 72 in the first direction D1 are changed, the sum of the area of the region where the end 62a and the end 71b opposing each other overlap each other and the area of the region where the end 62b and the end 72a opposing each other overlap each other tends not to change. As a result, regardless of the relative positions of the internal electrode 62 and the internal electrode 71 exposed to the side surface 2a and the internal electrode 72 opposing each other in the first direction D1, the chip varistor 1 can obtain the desired characteristics.

In the chip varistor 1, the distance d2 and the distance d5 are twice or more of the distance d7 and the distance d8. In a configuration in which the distance d2 and the distance d5 are twice or more of the distance d7 and the distance d8, the discharge tends not to occur between the internal electrode 51 and the external electrode 4 and between the internal electrode 71 and the external electrode 4. Therefore, the chip varistor 1 can further prevent the deterioration of the characteristics.

In the chip varistor 1, the distance d3 and the distance do are twice or more of the distance d7 and the distance d8. In a configuration in which the distance d3 and the distance d6 are twice or more of the distance d7 and the distance d8, the discharge tends not to occur between the internal electrode 51 and the internal electrode 52 and between the internal electrode 71 and the internal electrode 72. Therefore, the chip varistor 1 can more reliably prevent the deterioration of the characteristics.

In the chip varstor1, each of the ends 52c and 52d includes an exposed end exposed to a corresponding side surface of the pair of the side surfaces 2c and 2d. A width of the exposed end of the ends 52c and 52d, that is, a length of the exposed end of the ends 52c and 52d in the first direction D1, may be smaller than the length L2. The width of the exposed end of the ends 52c and 52d may be smaller than 100 μm. A configuration in which the widths of the exposed end of the ends 52c and 52d is smaller than the length L2 reliably maintains electric connection between the inner electrode 52 and the outer electrode regardless of position of the internal electrode 52. Therefore, the configuration in which the width of the exposed end of the ends 52c and 52d is smaller than the length L2 improve the resistance to the electrostatic discharge.

In the chip varstor1, each of the ends 72c and 72d includes an exposed end exposed to a corresponding side surface of the pair of the side surfaces 2c and 2d. Widths of the exposed end of the ends 72c and 72d, that is, lengths of the exposed end of the ends 72c and 72d in the first direction D1 may be smaller than the length L6. The widths of the exposed end of the ends 72c and 72d may be smaller than 100 μm. A configuration in which the widths of the exposed end of the ends 72c and 72d is smaller than the length L2 reliably maintains electric connection between the inner electrode 72 and the outer electrode 4 regardless of position of the internal electrode 72. Therefore, the configuration in which the width of the exposed end of the ends 72c and 72d is smaller than the length L6 improve the resistance to the electrostatic discharge.

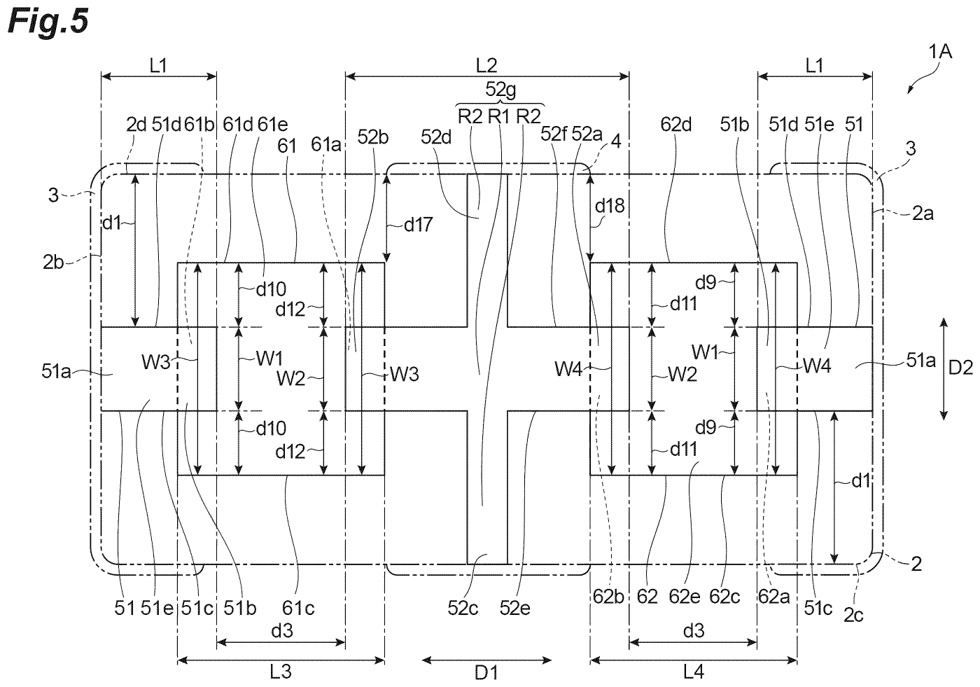

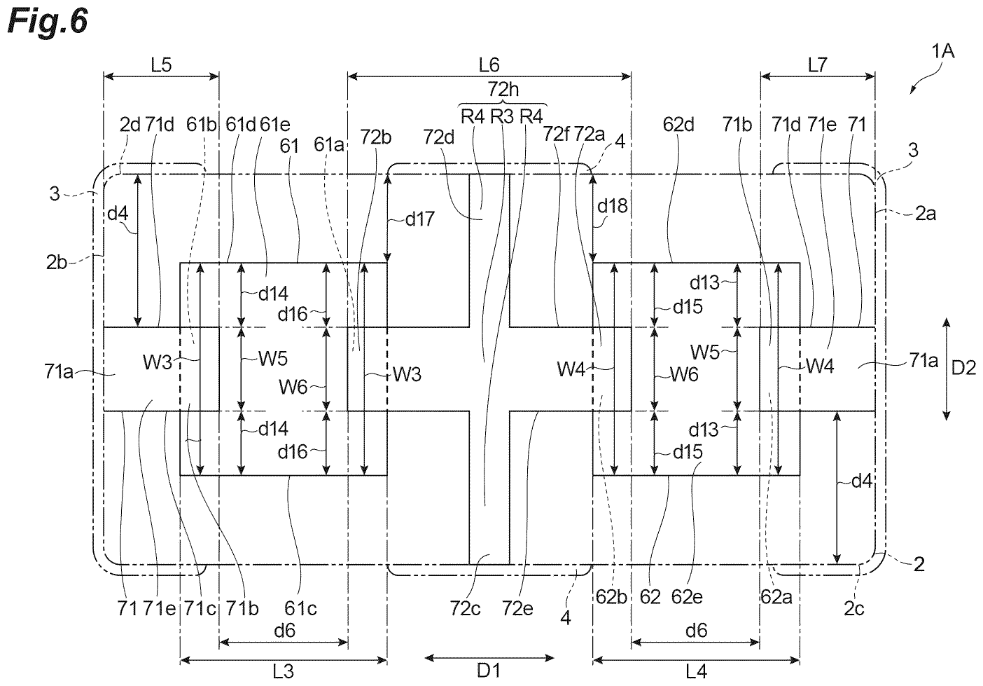

Next, a configuration of a chip varistor 1A according to a first modified example of the present embodiment will be described with reference to FIGS. 5 and 6. FIG. 5 is a view illustrating the configuration of the plurality of internal electrodes. FIG. 5 is a view of the pair of internal electrodes 51 and the internal electrode 52 and the internal electrodes 61 and 62 when viewed in a direction from the side surface 2e toward the side surface 2f in the third direction D3. FIG. 6 is a view illustrating the configuration of the plurality of internal electrodes. FIG. 6 is a view of the internal electrodes 61 and 62, the pair of internal electrodes 71 and the internal electrode 72 when viewed in a direction from the side surface 2f toward the side surface 2e in the third direction D3. The chip varistor 1A is different from the chip varistor 1 described above in terms of the values of the lengths L1 to L6 and the widths W1 to W6 and magnitude relationship of the widths W1 to W6. Hereinafter, the differences between the chip varistor 1 described above and the chip varistor 1A will be mainly described.

In the present modified example, the length L1 is 0.28 mm, and the width W1 is 0.2 mm. In the present modified example as well, the pair of internal electrodes 51 has the same length L1 and the same width W1.

In the present modified example, the distance d1 is 0.36 mm. In the present modified example as well, the distance d1 between the internal electrode 51 exposed to the side surface 2a and the outer surface of the element body 2 and the distance d1 between the internal electrode 51 exposed to the side surface 2b and the outer surface of the element body 2 are the same.

In the present modified example, the length L2 is 0.69 mm, and the width W2 is 0.2 mm. In the present modified example as well, the internal electrode 52 has the same length L2 and the same width W2 at each end 52a and 52b.

In the present modified example, the distance d3 is 0.3 mm. Also in the present modified example, the distance d3 between the internal electrode 51 exposed to the side surface 2a and the internal electrode 52 and the distance d3 between the internal electrode 51 exposed to the side surface 2b and the internal electrode 52 are the same.

In the present modified example, the length L3 is 0.5 mm, and the width W3 is 0.5 mm. In the present modified example as well, the internal electrode 61 has the same length L3 and the same width W3 at each end 61a and 61b.

In the present modified example, the length L4 is 0.5 mm, and the width W4 is 0.5 mm. In the present modified example as well, the internal electrode 62 has the same length L4 and the same width W4 at each end 62a and 62b.

In the present modified example, the length L5 is 0.28 mm, and the width W5 is 0.2 mm. In the present modified example as well, the pair of internal electrodes 71 has the same length L5 and the same width W5.

In the present modified example, the distance d4 is 0.36 mm. In the present modified example as well, the distance d4 between the internal electrode 71 exposed to the side surface 2a and the outer surface of the element body 2 and the distance d4 between the internal electrode 71 exposed to the side surface 2b and the outer surface of the element body 2 are the same.

In the present modified example, the length L6 is 0.69 mm, and the width W6 is 0.2 mm. In the present modified example as well, the internal electrode 72 has the same length L6 and the same width W6 at each end 72a and 72b.

In the present modified example, the distance d6 is 0.3 mm. Also in the present modified example, the distance d6 between the internal electrode 71 exposed to the side surface 2a and the internal electrode 72 and the distance d6 between the internal electrode 71 exposed to the side surface 2b and the internal electrode 72 are the same.

In the internal electrode layer 6, a distance d17 between the internal electrode 61 and the external electrode 4 and a distance d18 between the internal electrode 62 and the external electrode 4 are, for example, larger than or equal to 0.1 mm and less than or equal to 0.35 mm. In the present modified example, the distance d17 and the distance d18 are 0.21 mm. In the present modified example, the distance d17 and the distance d18 are larger than the distance d7 and the distance d8. The distance d17 and the distance d18 are, for example, twice or more of the distance d7 and the distance d8.

The distance d17 includes, for example, a shortest distance between each corner of the internal electrode 61 at the end 61a and the external electrode 4 when viewed from the third direction D3. In the present modified example, the distance d17 between the corner positioned closer to the side surface 2c among both corners of the internal electrode 61 at the end 61a and the external electrode 4 and the distance d17 between the corner positioned closer to the side surface 2d among both corners of the internal electrode 61 at the end 61a and the external electrode 4 are the same. The distance d17 between the corner positioned closer to the side surface 2c among both corners of the internal electrode 61 at the end 61a and the external electrode 4 and the distance d17 between the corner positioned closer to the side surface 2d among both corners of the internal electrode 61 at the end 61a and the external electrode 4 may be different from each other.

The distance d18 includes, for example, a shortest distance between each corner of the internal electrode 62 at the end 62b and the external electrode 4 when viewed from the third direction D3. In the present modified example, the distance d18 between the corner positioned closer to the side surface 2c among both corners of the internal electrode 62 at the end 62b and the external electrode 4 and the distance d18 between the corner positioned closer to the side surface 2d among both corners of the internal electrode 62 at the end 62b and the external electrode 4 are the same. The distance d18 between the corner positioned closer to the side surface 2c among both corners of the internal electrode 62 at the end 62b and the external electrode 4 and the distance d18 between the corner positioned closer to the side surface 2d among both corners of the internal electrode 62 at the end 62b and the external electrode 4 may be different from each other.

Unlike the above-described embodiment, in the present modified example, the width W1 of the internal electrode 51 exposed to the side surface 2a is smaller than the width W4 at the end 62a. Therefore, when viewed from the third direction D3, the pair of end edges 62c and 62d at the end 62a is positioned on the outer side of the pair of end edges 51c and 51d at the end 51b of the internal electrode 51 exposed to the side surface 2a.

In the present modified example, the width W1 of the internal electrode 51 exposed to the side surface 2b is smaller than the width W3 at the end 61b. Therefore, in the present modified example, when viewed from the third direction D3, the pair of end edges 61c and 61d at the end 61b is positioned on the outer side of the pair of end edges 51c and 51d at the end 51b of the internal electrode 51 exposed to the side surface 2b.

In the present modified example, the width W2 at the end 52a is smaller than the width W4 at the end 62b. Therefore, when viewed from the third direction D3, the pair of end edges 62c and 62d at the end 62b is positioned on the outer side of the pair of end edges 52e and 52f at the end 52a.

In the present modified example, the width W2 at the end 52b is smaller than the width W4 at the end 61a. Therefore, when viewed from the third direction D3, the pair of end edges 62c and 62d at the end 61a is positioned on the outer side of the pair of end edges 52e and 52f at the end 52b.

In the present modified example, the width W5 of the internal electrode 71 exposed to the side surface 2a is smaller than the width W4 at the end 62a. Therefore, in the present modified example, when viewed from the third direction D3, the pair of end edges 62c and 62d at the end 62a is positioned on the outer side of the pair of end edges 71c and 71d at the end 71b of the internal electrode 71 exposed to the side surface 2a.

In the present modified example, the width W5 of the internal electrode 71 exposed to the side surface 2b is smaller than the width W3 at the end 61b. Therefore, in the present modified example, when viewed from the third direction D3, the pair of end edges 61c and 61d at the end 61b is positioned on the outer side of the pair of end edges 71c and 71d at the end 71b of the internal electrode 71 exposed to the side surface 2b.

In the present modified example, the width W6 at the end 72a is smaller than the width W4 at the end 62b. Therefore, when viewed from the third direction D3, the pair of end edges 62c and 62d at the end 62b is positioned on the outer side of the pair of end edges 72e and 72f at the end 72a.

In the present modified example, the width W6 at the end 72b is smaller than the width W3 at the end 61a. Therefore, when viewed from the third direction D3, the pair of end edges 62c and 62d at the end 61a is positioned on the outer side of the pair of end edges 72e and 72f at the end 72b.

In the chip varistor 1A, the width W3 is larger than the corresponding widths W1 and W2, and the width W4 is larger than the corresponding widths W1 and W2. In the configuration in which the width W3 is larger than the corresponding widths W1 and W2 and the width W4 is larger than the corresponding widths W1 and W2, an internal electrode paste used to form the plurality of internal electrodes 51, 52, 61, and 62 can be reduced as compared with the configuration in which the width W3 is smaller than the corresponding widths W1 and W2 and the width W4 is smaller than the corresponding widths W1 and

W2. Therefore, the chip varistor 1A can easily form the plurality of internal electrodes 51, 52, 61, and 62.

In the chip varistor 1A, the width W3 is larger than the corresponding widths W5 and W6, and the width W4 is larger than the corresponding widths W5 and W6. In the configuration in which the width W3 is larger than the corresponding widths W5 and W6 and the width W4 is larger than the corresponding widths W5 and W6, the internal electrode paste used to form the plurality of internal electrodes 61, 62, 71, and 72 can be reduced as compared with the configuration in which the width W3 is smaller than the corresponding widths W5 and W6 and the width W4 is smaller than the corresponding widths W5 and W6. Therefore, the chip varistor 1A can easily form the plurality of internal electrodes 61, 62, 71, and 72.

In the chip varistor 1A, the distance d17 and the distance d18 are twice or more of the distance d7 and the distance d8. In the configuration in which the distance d17 and the distance d18 are twice or more of the distance d7 and the distance d8, discharge tends not to occur between the internal electrode 61 and the external electrode 4 and between the internal electrode 62 and the external electrode 4. Therefore, the chip varistor 1A can further prevent the deterioration of the characteristics.

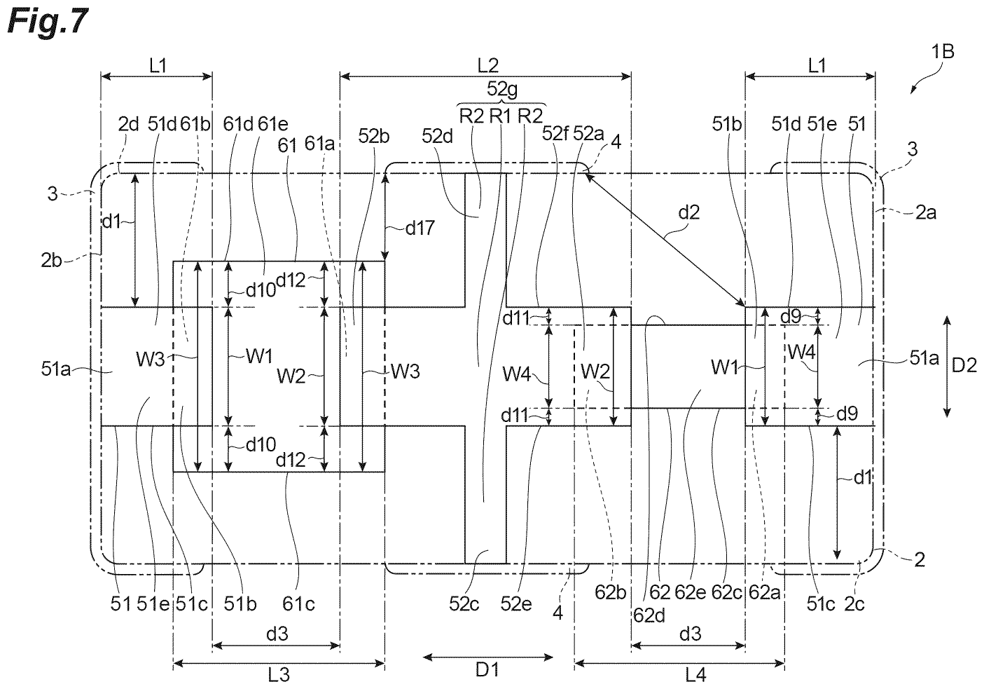

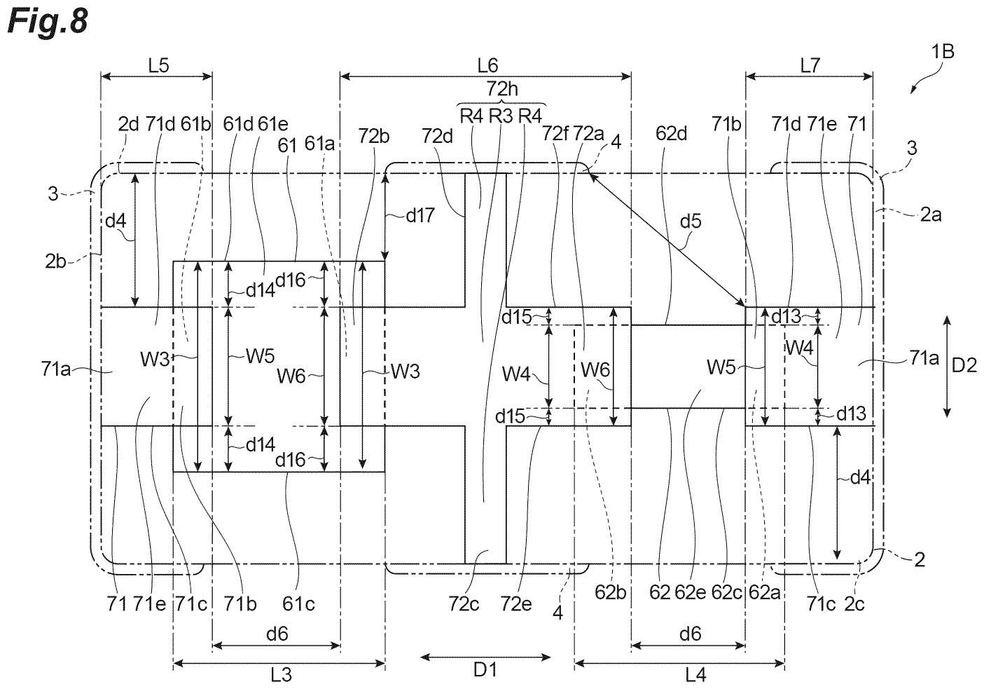

Next, a configuration of a chip varistor 1B according to a second modified example of the present embodiment will be described with reference to FIGS. 7 and 8. FIG. 7 is a view illustrating the configuration of the plurality of internal electrodes. FIG. 7 is a view of the pair of internal electrodes 51 and the internal electrode 52 and the internal electrodes 61 and 62 when viewed in a direction from the side surface 2e toward the side surface 2f in the third direction D3. FIG. 8 is a view illustrating the configuration of the plurality of internal electrodes. FIG. 8 is a view of the internal electrodes 61 and 62, the pair of internal electrodes 71 and the internal electrode 72 when viewed in a direction from the side surface 2f toward the side surface 2e in the third direction D3. The chip varistor 1B is different from the chip varistor 1A described above in terms of the values of the widths W1, W2, W4, W5, and W6 and the magnitude relationship of the widths W1 to W6.

Hereinafter, the differences between the chip varistor 1A described above and the chip varistor 1B will be mainly described.

The width W1 and the width W2 in the present modified example are 0.3 mm. In the present modified example as well, the pair of internal electrodes 51 has the same width W1, and the internal electrode 52 has the same length L2 and the same width W2 at each of the ends 52a and 52b. The width W4 in the present modified example is 0.2 mm. Also in the present modified example, the internal electrode 62 has the same width W4 at each of the ends 62a and 62b. The width W5 and the width W6 in the present modified example are 0.3 mm. In the present modified example as well, the pair of internal electrodes 71 has the same width W5, and the internal electrode 72 has the same width W6 at each of the ends 72a and 72b.

The distance d1 in the present modified example is 0.31 mm. In the present modified example as well, the distance d1 between the internal electrode 51 exposed to the side surface 2a and the outer surface of the element body 2 and the distance d1 between the internal electrode 51 exposed to the side surface 2b and the outer surface of the element body 2 are the same. The distance d4 in the present modified example is 0.31 mm. In the present modified example as well, the distance d4 between the internal electrode 71 exposed to the side surface 2a and the outer surface of the element body 2 and the distance d4 between the internal electrode 71 exposed to the side surface 2b and the outer surface of the element body 2 are the same.

Also in the present modified example, the width W3 is larger than the corresponding widths W1 and W2. However, while the width W3 in the present modified example is the same as the width W3 in the first modified example, the widths W1 and W2 in the present modified example is different from the widths W1 and W2 in the first modified example. Therefore, in the present modified example, the distances d10 and d12 are also different from the distances d10 and d12 in the first modified example. The distances d10 and d12 in the present modified example are 0.1 mm.

Also in the present modified example, the width W3 is larger than the corresponding widths W5 and W6. However, while the width W3 in the present modified example is the same as the width W3 in the first modified example, the widths W5 and W6 in the present modified example are different from the widths W5 and W6 in the first modified example. Therefore, in the present modified example, the distances d14 and d16 are also different from the distances d14 and d16 in the first modified example. The distances d14 and d16 in the present modified example are 0.1 mm.

Unlike the first modified example described above, in the present modified example, the width W1 of the internal electrode 51 exposed to the side surface 2a is larger than the width W4 at the end 62a. Therefore, when viewed from the third direction D3, the pair of end edges 51c and 51d at the end 51b of the internal electrode 51 exposed to the side surface 2a is positioned on the outer side of the pair of end edges 62c and 62d at the end 62a. The distance d9 in the present modified example is 0.05 mm.

In the present modified example, the width W2 at the end 52a is larger than the width W4 at the end 62b. Therefore, when viewed from the third direction D3, the pair of end edges 52e and 52f at the end 52a is positioned on the outer side of the pair of end edges 62c and 62d at the end 62b. The distance d11 in the present modified example is 0.05 mm.

In the present modified example, the width W5 of the internal electrode 71 exposed to the side surface 2a is larger than the width W4 at the end 62a. Therefore, when viewed from the third direction D3, the pair of end edges 71c and 71d at the end 71b of the internal electrode 71 exposed to the side surface 2a is positioned on the outer side of the pair of end edges 62c and 62d at the end 62a. The distance d13 in the present modified example is 0.05 mm.

In the present modified example, the width W6 at the end 72a is larger than the width W4 at the end 62b. Therefore, when viewed from the third direction D3, the pair of end edges 72e and 72f at the end 72a is positioned on the outer side of the pair of end edges 62c and 62d at the end 62b. The distance d15 in the present modified example is 0.05 mm.

As described above, in the present modified example, the magnitude relationship between the widths W1 and W2 and the width W3 closer to the side surface 2a and the magnitude relationship between the widths W1 and W2 and the width W4 closer to the side surface 2b are reversed. Similarly, the magnitude relationship between the widths W5 and W6 and the width W3 closer to the side surface 2a and the magnitude relationship between the widths W5 and W6 and the width W4 closer to the side surface 2b are reversed.

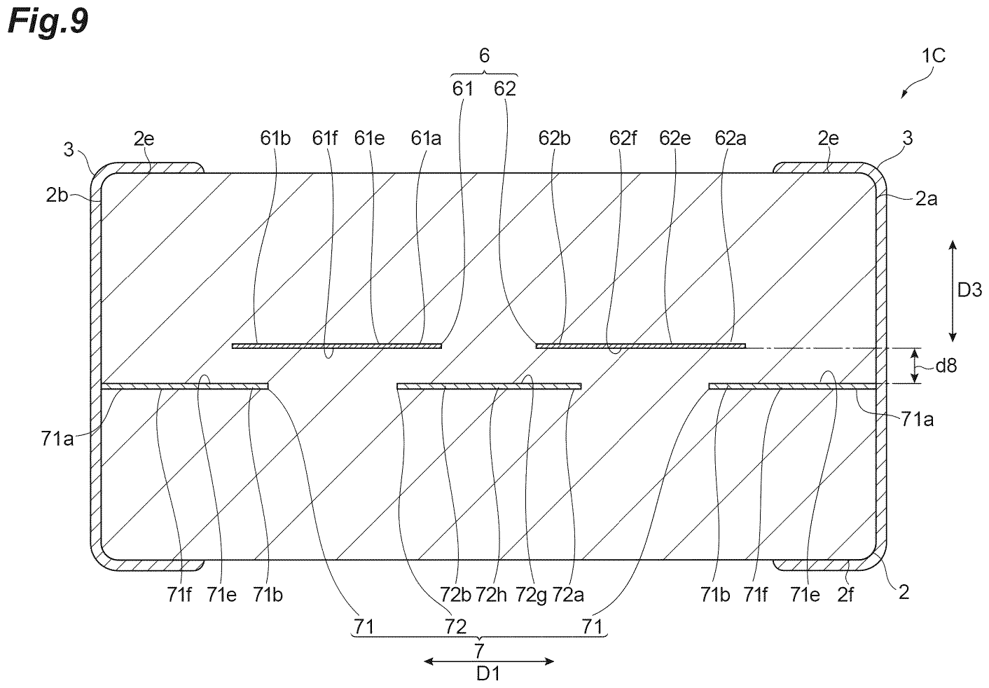

Next, a configuration of a chip varistor 1C according to a third modified example of the present embodiment will be described with reference to FIG. 9. FIG. 9 is a diagram illustrating a cross-sectional configuration of a chip varistor according to a modified example of the first embodiment. The chip varistor 1C is different from the chip varistor 1 described above in terms of the configuration of the plurality of internal electrodes. Hereinafter, the differences between the chip varistor 1 described above and the chip varistor 1C will be mainly described.

In the present modified example, the plurality of internal electrodes include the plurality of internal electrode layers 6 and 7. That is, in the chip varistor 1C, the plurality of internal electrodes do not include the plurality of internal electrode layers 5. The internal electrode layers 6 and 7 are disposed in the element body 2. As illustrated in FIG. 9, in the present modified example, the internal electrode layer 6 and the internal electrode layer 7 are arranged in this order in the third direction D3 in the element body 2.

In the present modified example, any magnitude relationship among the magnitude relationships of the widths W3 to W6 in the chip varistors 1, 1A, and 1B may be adopted. The width W5 of the internal electrode 71 exposed to the side surface 2a may be smaller than the width W4 at the end 62a, or may be larger than the width W4 at the end 62a. The width W5 of the internal electrode 71 exposed to the side surface 2b may be smaller than the width W3 at the end 61b, or may be larger than the width W3 at the end 61b. The width W6 at the end 72a may be smaller than the width W4 at the end 62b, or may be larger than the width W4 at the end 62b. The width W6 at the end 72b may be smaller than the width W3 at the end 61a, or may be larger than the width W3 at the end 61a.

In the present modified example, the internal electrodes 61 and 62 are positioned in the same layer with each other, and the internal electrodes 71 and 72 are positioned in the same layer with each other. However, positional relationship among the internal electrodes 61, 62, 71, and 72 is not limited to the above-described positional relationship. For example, the internal electrodes 61, 62, 71, and 72 may be positioned in different layers from each other. In the configuration in which the internal electrodes 61, 62, 71, and 72 are positioned in different layers from each other, the internal electrodes 61, 62, 71, and 72 may be arranged in a direction inclined in the third direction D3 when viewed from the second direction D2.

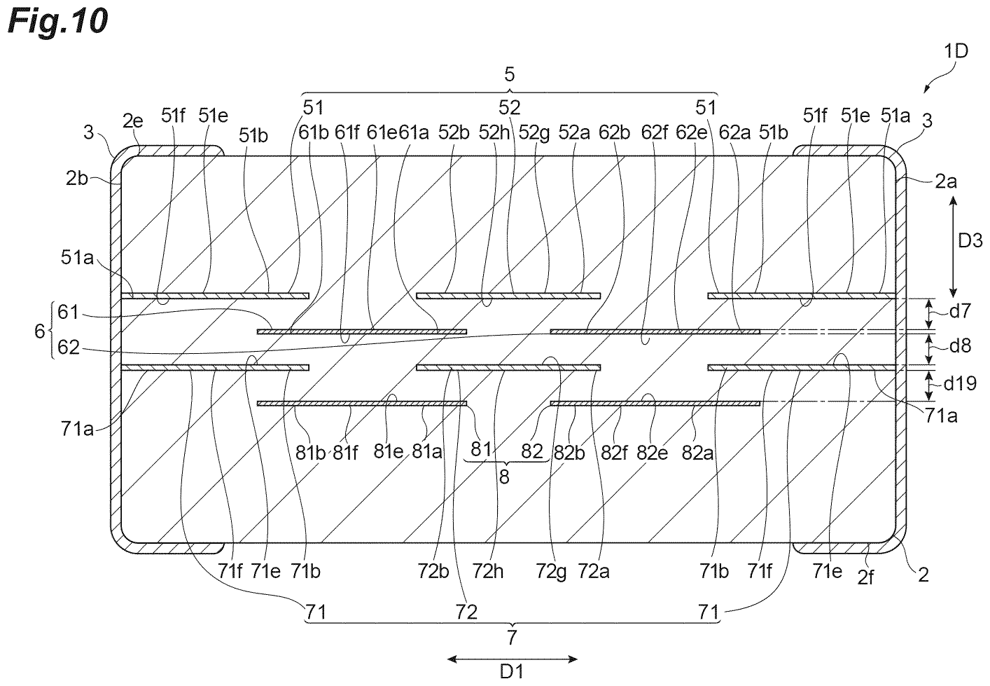

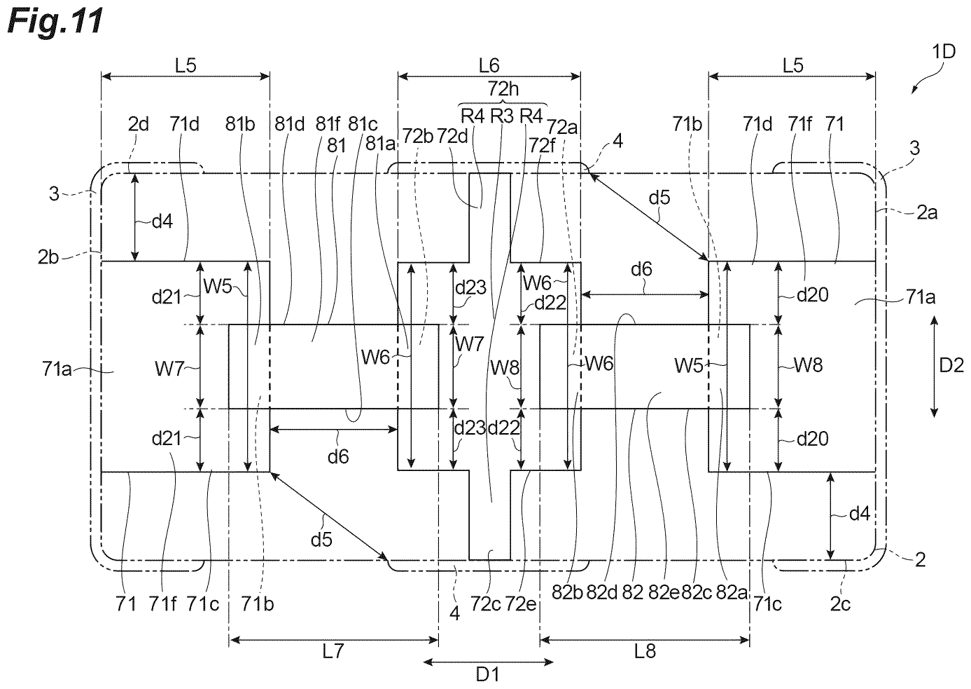

Next, a configuration of a chip varistor 1D according to a fourth modified example of the present embodiment will be described with reference to FIGS. 10 and 11. FIG. 10 is a diagram illustrating a cross-sectional configuration of a chip varistor according to another modified example of the present embodiment. FIG. 11 is a diagram illustrating a configuration of the plurality of internal electrodes. The chip varistor 1D is different from the chip varistor 1 described above in terms of the configuration of the plurality of internal electrodes. Hereinafter, the differences between the chip varistor 1 described above and the chip varistor 1D will be mainly described.

In the present modified example, the plurality of internal electrodes include the internal electrode layers 5, 6, and 7, and an internal electrode layer 8. The internal electrode layer 8 is disposed in the element body 2. The internal electrode layer 8 is disposed at a position different from the internal electrode layers 5, 6, and 7 in the third direction D3 in the element body 2. The internal electrode layer 8 is adjacent to the internal electrode layer 7 in such a manner that the internal electrode layer 7 is positioned between the internal electrode layer 8 and the internal electrode layer 6. That is, in the present modified example, the internal electrode layer 7 is positioned between the internal electrode layer 6 and the internal electrode layer 8. In the present modified example, in the element body 2, the internal electrode layers 5, the internal electrode layers 6, the internal electrode layer 7, and the internal electrode layer 8 are arranged in this order in the third direction D3. In the element body 2, the internal electrode layer 8, the internal electrode layer 7, the internal electrode layer 6, and the internal electrode layer 5 may be arranged in this order in the third direction D3.

The internal electrode layer 8 includes an internal electrode 81 and an internal electrode 82. In the present modified example, the internal electrode layer 8 includes one internal electrode 81 and one internal electrode 82. The internal electrode 81 and the internal electrode 82 extend in the first direction D1. The internal electrode 81 and the internal electrode 82 are positioned in the same layer in the element body 2. The internal electrode 81 and the internal electrode 82 are disposed at the same position in the third direction D3. The internal electrode 81 and the internal electrode 82 are separated from each other in the same layer, and are not exposed to the outer surface of the element body 2. The internal electrode 81 and the internal electrode 82 oppose each other in the first direction D1 in the same layer.

The internal electrodes 81 and 82 included in the internal electrode layer 8 oppose the internal electrodes 71 and 72 in the third direction D3, which are included in the internal electrode layer 7 adjacent to the internal electrode layer 8 in the third direction D3. In the present modified example, in the internal electrode layer 7 and the internal electrode layer 8, the internal electrode 81 opposes the internal electrode 71 exposed to the side surface 2b and the internal electrode 72 in the third direction D3. In the internal electrode layer 7 and the internal electrode layer 8, the internal electrode 82 opposes the internal electrode 71 exposed to the side surface 2a and the internal electrode 72 in the third direction D3.

As illustrated in FIGS. 10 and 11, the internal electrode 81 includes a pair of ends 81a and 81b, a pair of end edges 81c and 81d opposing each other, and a pair of surfaces 81e and 81f opposing each other. FIG. 11 is a view of the pair of internal electrodes 71 and the internal electrode 72 and the internal electrodes 81 and 82 when viewed from the side surface 2f toward the side surface 2e in the third direction D3.

The pair of ends 81a and 81b defines both ends of the internal electrode 81 in the first direction D1. The end 81a and the end 81b are positioned in the element body 2 and are not exposed to the outer surface of the element body 2. The end 81a and the end 81b are separated apart from each of the side surfaces 2a and 2b. The end 81a is positioned closer to the side surface 2a and opposes the internal electrode 82 in the first direction D1. The end 81b is positioned on the opposite side of the end 81a.

The internal electrode 81 opposes the internal electrode 72 in the third direction D3 at the end 81a. In the present modified example, the end 81a opposes the end 72b of the internal electrode 72 in the third direction D3. The end 81a includes a region overlapping the internal electrode 72 when viewed from the third direction D3. In the present modified example, the end 81a includes a region overlapping the end 72b when viewed from the third direction D3. That is, the end 81a and the end 72b overlap each other when viewed from the third direction D3. In the present modified example, the region of the end 81a extends from an end of the internal electrode 81 at the end 81a to the end of the internal electrode 72 at the end 72b when viewed from the third direction D3. That is, the end 81a includes the end of the internal electrode 81 and a region from the end of the internal electrode 81 to a predetermined length.

The internal electrode 81 opposes the internal electrode 71 exposed to the side surface 2b in the third direction D3 at the end 81b. In the present modified example, the end 81b opposes the end 71b of the internal electrode 71 exposed to the side surface 2b in the third direction D3. The end 81b includes a region overlapping the internal electrode 71 exposed to the side surface 2b when viewed from the third direction D3.

In the present modified example, the end 81b includes a region overlapping the end 71b of the internal electrode 71 exposed to the side surface 2b when viewed from the third direction D3. That is, when viewed from the third direction D3, the end 81b and the end 71b of the internal electrode 71 exposed to the side surface 2b overlap each other. In the present modified example, the region of the end 81b extends from an end of the internal electrode 81 at the end 81b to the end of the end 71b of the internal electrode 71 exposed to the side surface 2b when viewed from the third direction D3. That is, the end 81b includes the end of the internal electrode 81 and a region from the end of the internal electrode 81 to a predetermined length.

The pair of end edges 81c and 81d opposes each other in the second direction D2, and the pair of surfaces 81and 81f opposes each other in the third direction D3. In the present modified example, the end edge 81c is positioned closer to the side surface 2c, and the end edge 81d is positioned closer to the side surface 2d. In the present modified example, the surface 81is positioned closer to the side surface 2e, and the surface 81f is positioned closer to the side surface 2f. Each of the end edges 81c and 81d may include a surface. Each of the end edges 81c and 81d is adjacent to each of the surface 81e and the surface 81f and couples the surface 81e and the surface 81f.

The internal electrode 81 has a length L7. The length L7 includes, for example, a length of the internal electrode 81 in the first direction D1. The length L7 is, for example, larger than or equal to 0.4 mm and less than or equal to 0.6 mm. The length L7 in the present modified example is 0.5 mm.

The internal electrode 81 has a width W7 at the ends 81a, 81b. That is, the ends 81a, 81b have the width W7. The width W7 includes, for example, the length of the internal electrode 81 in the second direction D2 at the ends 81a, 81b. The width W7 is, for example, larger than or equal to 0.1 mm and less than or equal to 0.5 mm. The width W7 in the present modified example is 0.2 mm. In the present modified example, the internal electrode 81 has the same width W7 at each of the ends 81a and 81b. The internal electrode 81 may have different widths W7 at each of the ends 81a and 81b.

In the present modified example, the internal electrode 81 has the width W7 throughout its entirety. The internal electrode 81 only needs to have the width W7 at the ends 81a and 81b. For example, the internal electrode 81 may have a width different from the width W7 at a position other than the ends 81a and 81b.

The internal electrode 82 includes a pair of ends 82a and 82b, a pair of end edges 82c and 82d opposing each other, and a pair of surfaces 82e and 82f opposing each other. The pair of ends 82a and 82b defines both ends of the internal electrode 82 in the first direction D1. The end 82a and the end 82b are positioned in the element body 2 and are not exposed to the outer surface of the element body 2. The end 82a and the end 82b are separated from each of the side surfaces 2a and 2b. The end 82a is positioned closer to the side surface 2a. The end 82b is positioned on the opposite side of the end 81a and faces the internal electrode 81 in the first direction D1.

The internal electrode 82 opposes the internal electrode 71 exposed to the side surface 2a in the third direction D3 at the end 82a. In the present modified example, the end 82a opposes the end 71b of the internal electrode 71 exposed to the side surface 2a in the third direction D3. The end 82a includes a region overlapping the internal electrode 71 exposed to the side surface 2a when viewed from the third direction D3. In the present modified example, the end 82a includes a region overlapping the end 71b of the internal electrode 71 exposed to the side surface 2a when viewed from the third direction D3. That is, when viewed from the third direction D3, the end 82a and the end 71b of the internal electrode 71 exposed to the side surface 2a overlap each other. In the present modified example, the region of the end 82a extends from an end of the internal electrode 81 at the end 82a to the end of the end 71b of the internal electrode 71 exposed to the side surface 2a when viewed from the third direction D3. That is, the end 82a includes the end of the internal electrode 82 and a region from the end of the internal electrode 82 to a predetermined length.

The internal electrode 82 oppose the internal electrode 72 in the third direction D3 at the end 82b. In the present modified example, the end 82b opposes the end 72a of the internal electrode 72 in the third direction D3. The end 82b includes a region overlapping the internal electrode 72 when viewed from the third direction D3. In the present modified example, the end 82b includes a region overlapping the end 72a when viewed from the third direction D3. That is, the end 82b and the end 72a overlap each other when viewed from the third direction D3. In the present modified example, the region of the end 82b extends from the end of the internal electrode 82 at the end 82b to the end of the internal electrode 72 at the end 72a when viewed from the third direction D3. That is, the end 82b includes the end of the internal electrode 82 and a region from the end of the internal electrode 82 to a predetermined length.

The pair of end edges 82c and 82d opposes each other in the second direction D2, and the pair of surfaces 82e and 82f opposes each other in the third direction D3. In the present modified example, the end edge 82c is positioned closer to the side surface 2c, and the end edge 82d is positioned closer to the side surface 2d. In the present modified example, the surface 82e is positioned closer to the side surface 2e, and the surface 82f is positioned closer to the side surface 2f. Each of the end edges 82c and 82d may include a surface. Each of the end edges 82c and 82d is adjacent to each of the surface 82e and the surface 82f and couples the surface 82e and the surface 82f.

The internal electrode 82 has a length L8. The length L8 includes, for example, a length of the internal electrode 82 in the first direction D1. The length L8 is, for example, larger than or equal to 0.4 mm and less than or equal to 0.6 mm. The length L8 in the present modified example is 0.5 mm.

The internal electrode 82 has a width W8 at the ends 82a, 82b. That is, the ends 82a, 82b have the width W8. The width W8 includes, for example, a length of the internal electrode 82 in the second direction D2 at the ends 82a, 82b. The width W8 is, for example, larger than or equal to 0.1 mm and less than or equal to 0.5 mm. The width W8 in the present modified example is 0.2 mm. In the present modified example, the internal electrode 82 has the same width W8 at each of the ends 82a and 82b. The internal electrode 82 may have different widths W8 at each of the ends 82a and 82b.

In the present modified example, the internal electrode 82 has the width W8 throughout its entirety. The internal electrode 82 only needs to have the width W8 at the ends 82a and 82b. For example, the internal electrode 82 may have a width different from the width W8 at a position other than the ends 82a and 82b.

A distance d19 between the internal electrode layer 7 and the internal electrode layer 8 illustrated in FIG. 10 is, for example, larger than or equal to 0.06 mm and less than or equal to 0.18 mm. The distance d19 may be larger than or equal to 0.09 mm and less than or equal to 0.12 mm. In the present modified example, the distance d19 is 0.09 mm.

For example, the distance d19 is different from the distance d2 between the internal electrode 71 and the external electrode 4 and the distance d5 between the internal electrode 71 and the external electrode 4. In the present modified example, the distance d2 and the distance d5 are larger than the distance d19. The distance d2 and the distance d5 are, for example, twice or more of the distance d19.

For example, the distance d19 is different from the distance d3 between the internal electrode 51 and the internal electrode 52 and the distance d6 between the internal electrode 71 and the internal electrode 72. In the present modified example, the distance d3 and the distance d6 are larger than the distance d19. The distance d3 and the distance d6 are, for example, twice or more of the distance d19.

In the chip varistor 1D, the varistor is formed between the internal electrode 81 and the internal electrodes 71 and 72. In the present modified example, the end 81b, the end 71b opposing the end 81b, and a region between the end 81b and the end 71b of the element body 2 function as a varistor between the internal electrode 81 and the internal electrode 71. The end 81a, the end 72b opposing the end 81a, and the region between the end 81a and the end 72b of the element body 2 function as a varistor between the internal electrode 81 and the internal electrode 72. These varistors are connected in series via the internal electrode 81. That is, the internal electrode 81 is disposed to form a plurality of varistors connected in series between the internal electrode 71 exposed to the side surface 2b and the internal electrode 72.

In the chip varistor 1D, the varistor is formed between the internal electrode 82 and the internal electrodes 71 and 72. In the present modified example, the end 82a, the end 71b opposing the end 82a, and a region between the end 82a and the end 71b of the element body 2 function as a varistor between the internal electrode 82 and the internal electrode 71. The end 82b, the end 72a opposing the end 82a, and the region between the end 82b and the end 72a of the element body 2 function as a varistor between the internal electrode 82 and the internal electrode 72. These varistors are connected in series via the internal electrode 82. That is, the internal electrode 82 is disposed to form a plurality of varistors connected in series between the internal electrode 71 exposed to the side surface 2a and the internal electrode 72.

The width W5 of the internal electrode 71 exposed to the side surface 2a and the width W8 at the end 82a are different from each other. In the present modified example, the width W5 of the internal electrode 71 exposed to the side surface 2a is larger than the width W8 at the end 82a. In the present modified example, when viewed from the third direction D3, the pair of end edges 71c and 71d at the end 71b of the internal electrode 71 exposed to the side surface 2a is positioned on the outer side of the pair of end edges 82c and 82d at the end 82a. A distance d20 includes a distance between the end edge 71c and the end edge 82c in the second direction D2 and a distance between the end edge 71d and the end edge 82d in the second direction D2. The distance d20 is, for example, larger than or equal to 0.05 mm and less than or equal to 0.20 mm. The distance d20 may be larger than or equal to 0.10 mm and less than or equal to 0.15 mm. The distance d20 in the present modified example is 0.15 mm. That is, in the present modified example, the distance d20 between the end edge 71c and the end edge 82c in the second direction D2 and the distance d20 between the end edge 71d and the end edge 82d in the second direction D2 are the same. The distance d20 between the end edge 71c and the end edge 82c in the second direction D2 and the distance d20 between the end edge 71d and the end edge 82d in the second direction D2 may be different from each other.

The width W5 of the internal electrode 71 exposed to the side surface 2b and the width W7 at the end 81b are different from each other. In the present modified example, the width W5 of the internal electrode 71 exposed to the side surface 2b is larger than the width W7 at the end 81b. In the present modified example, when viewed from the third direction D3, the pair of end edges 71c and 71d at the end 71b of the internal electrode 71 exposed to the side surface 2b is positioned on the outer side of the pair of end edges 81c and 81d at the end 81b. A distance d21 includes a distance between the end edge 71c and the end edge 81c in the second direction D2 and a distance between the end edge 71d and the end edge 81d in the second direction D2. The distance d21 is, for example, larger than or equal to 0.05 mm and less than or equal to 0.20 mm. The distance d21 may be larger than or equal to 0.10 mm and less than or equal to 0.15 mm. Each distance d21 in the present modified example is 0.15 mm. That is, in the present modified example, the distance d21 between the end edge 71c and the end edge 81c in the second direction D2 and the distance d21 between the end edge 71d and the end edge 81d in the second direction D2 are the same. The distance d21 between the end edge 71c and the end edge 81c in the second direction D2 and the distance d21 between the end edge 71d and the end edge 81d in the second direction D2 may be different from each other.

For example, the length L5 of the pair of internal electrodes 71, the length L7 of the internal electrode 81, and the length L8 of the internal electrode 82 are different from each other. In the present modified example, the length L7 and the length L8 are larger than the length L5. For example, the width W7 of the internal electrode 81 and the width W8 of the internal electrode 82, and the distance d4 between the pair of internal electrodes 71 and the outer surface of the element body 2 are different from each other. In the present modified example, the width W5 and the width W6 are larger than each distance d4.

For example, a length of the end 81a in the first direction D1 and the length L6 of the internal electrode 72 are different from each other, and the length of the end 81b in the first direction D1 and the length L5 of the internal electrode 71 exposed to the side surface 2b are different from each other. In the present modified example, the length of the end 81a in the first direction D1 is smaller than the length L6, and the length of the end 81b in the first direction D1 is smaller than the length L5 of the internal electrode 71 exposed to the side surface 2b.

For example, a length of the end 82a in the first direction D1 and the length L5 of the internal electrode 71 exposed to the side surface 2a are different from each other, and the length of the end 82b in the first direction D1 and the length L6 of the internal electrode 72 are different from each other. In the present modified example, the length of the end 82a in the first direction D1 is smaller than the length L5 of the internal electrode 71 exposed to the side surface 2b, and the length of the end 82b in the first direction D1 is smaller than the length L6.

The width W6 at the end 72a and the width W8 at the end 82b are different from each other. In the present modified example, the width W6 at the end 72a is larger than the width W8 at the end 82b. In the present modified example, when viewed from the third direction D3, the pair of end edges 72e and 72f at the end 72a is positioned on the outer side of the pair of end edges 82c and 82d at the end 82b. A distance d22 includes distance between the end edge 72e and the end edge 82c in the second direction D2 and a distance between the end edge 72f and the end edge 82d in the second direction D2. The distance d22 is, for example, larger than or equal to 0.05 mm and less than or equal to 0.20 mm. The distance d22 may be larger than or equal to 0.10 mm and less than or equal to 0.15 mm. Each distance d22 in the present modified example is 0.15 mm. That is, in the present modified example, the distance d22 between the end edge 72e and the end edge 82c in the second direction D2 and the distance d22 between the end edge 72f and the end edge 82d in the second direction D2 are the same. The distance d22 between the end edge 72e and the end edge 82c in the second direction D2 and the distance d22 between the end edge 72f and the end edge 82d in the second direction D2 may be different from each other.

The width W6 at the end 72b and the width W7 at the end 81a are different from each other. In the present modified example, the width W6 at the end 72b is larger than the width W7 at the end 81a. In the present modified example, when viewed from the third direction D3, the pair of end edges 72e and 72f at the end 72b is positioned on the outer side of the pair of end edges 82c and 82d at the end 81a. A distance d23 includes distance between the end edge 72e and the end edge 82c in the second direction D2 and a distance between the end edge 72f and the end edge 82d in the second direction D2. The distance d23 is, for example, larger than or equal to 0.05 mm and less than or equal to 0.20 mm. The distance d23 may be larger than or equal to 0.10 mm and less than or equal to 0.15 mm. Each distance d23 in the present modified example is 0.15 mm. That is, in the present modified example, the distance d23 between the end edge 72e and the end edge 82c in the second direction D2 and the distance d23 between the end edge 72f and the end edge 82d in the second direction D2 are the same. The distance d23 between the end edge 72e and the end edge 82c in the second direction D2 and the distance d23 between the end edge 72f and the end edge 82d in the second direction D2 may be different from each other.

Any one of the magnitude relationships of each of the widths W3 to W6 in the chip varistors 1A and 1B may be adopted as the magnitude relationships of each of the widths W5 to W8 in the present modified example. The width W5 of the internal electrode 71 exposed to the side surface 2a may be smaller than the width W8 at the end 82a. The width W5 of the internal electrode 71 exposed to the side surface 2b may be smaller than the width W7 at the end 81b. The width W6 at the end 72a may be smaller than the width W8 at the end 82b. The width W6 at the end 72b may be smaller than the width W7 at the end 81a.

In the chip varistor 1D, the width W5 of the internal electrode 71 exposed to the side surface 2a is different from the width W8 of the internal electrode 82. Therefore, regardless of a relative position of the internal electrode 71 exposed to the side surface 2a and the internal electrode 82 in the second direction D2, the area of the region where the end 71b and the end 82a opposing each other overlap each other tends not to change. As result, regardless of the relative position of the internal electrodes 71 and 82 each other in the second direction D2, the chip varistor 1D can obtain the desired characteristics.

In the chip varistor 1D, the width W5 of the internal electrode 71 exposed to the side surface 2b is different from the width W7 of the internal electrode 81. Therefore, regardless of a relative position of the internal electrode 71 exposed to the side surface 2b and the internal electrode 81 in the second direction D2, the area of the region where the end 71b and the end 81b opposing each other overlap each other tends not to change. As a result, regardless of the relative position of the internal electrodes 71 and 81opposing each other in the second direction D2, the chip varistor 1D can obtain the desired characteristics.

In the chip varistor 1D, the width W6 of the internal electrode 72 at the end 72a is different from the width W8 of the internal electrode 82 at the end 82b. Therefore, even in a configuration in which a relative position of the internal electrode 72 and the internal electrode 82 in the second direction D2 is changed, the area of the region where the end 72a and the end 82b opposing each other overlap tends not to change. As a result, even in the configuration in which the relative position of the internal electrodes 72 and 82 opposing each other in the second direction D2 are changed, the chip varistor 1D can obtain the desired characteristics.

In the chip varistor 1D, the width W6 of the internal electrode 72 at the end 72b is different from the width W7 of the internal electrode 81 at the end 81a. Therefore, regardless of a relative position of the internal electrode 72 and the internal electrode 81 in the second direction D2, changed, the area of the region where the end 72a and the end 81a opposing each other overlap tends not to change. As a result, regardless of the relative position of the internal electrodes 72 and 81 opposing each other in the second direction D2, the chip varistor 1D can obtain the desired characteristics.

In the chip varistor 1D, the length of the end 81a in the first direction D1 is smaller than the length L6, and the length of the end 81b in the first direction D1 is smaller than the length L5 of the internal electrode 71 exposed to the side surface 2b. Therefore, regardless of relative positions of the internal electrode 81, and the internal electrode 71 exposed to the side surface 2b and the internal electrode 72 in the first direction D1, the sum of the area of the region where the end 81b and the end 71b opposing each other overlap each other and the area of the region where the end 81a and the end 72b opposing each other overlap each other tends not to change. As a result, regardless of the relative positions of the internal electrode 81 and the internal electrode 71 exposed to the side surface 2b and the internal electrode 72 opposing each other in the first direction D1, the chip varistor 1D can obtain the desired characteristics.

In the chip varistor 1D, the length of the end 82a in the first direction D1 is smaller than the length L5 of the internal electrode 71 exposed to the side surface 2a, and the length of the end 82b in the first direction D1 is smaller than the length L6. Therefore, regardless of relative positions of the internal electrode 82, and the internal electrode 71 exposed to the side surface 2a and the internal electrode 72 in the first direction D1, the sum of the area of the region where the end 82a and the end 71b opposing each other overlap each other and the area of the region where the end 82b and the end 72a opposing each other overlap each other tends not to change. As a result, regardless of the relative positions of the internal electrode 82, and the internal electrode 71 exposed to the side surface 2a and the internal electrode 72 opposing each other in the first direction D1, the chip varistor 1D can obtain the desired characteristics.

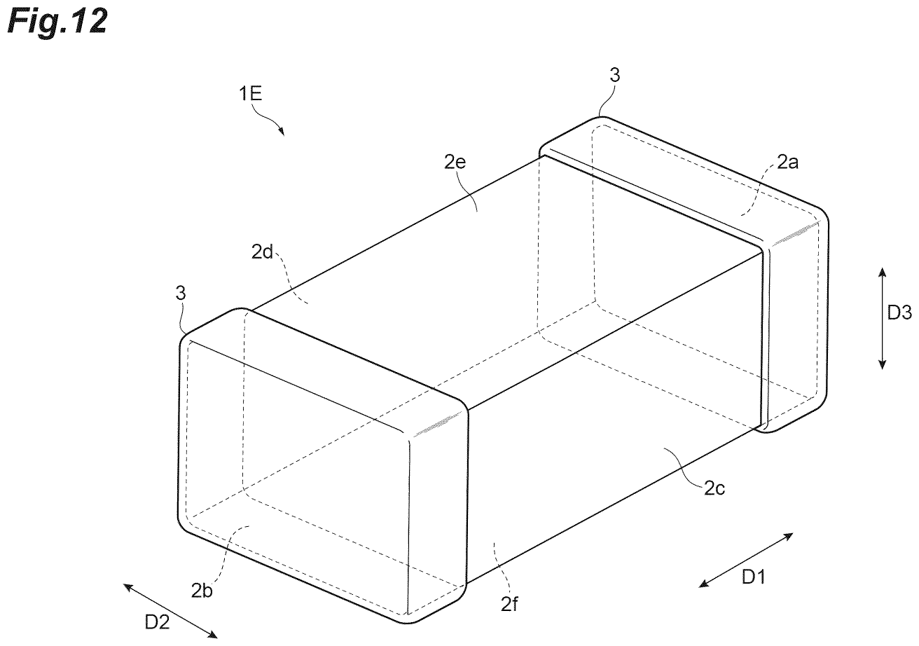

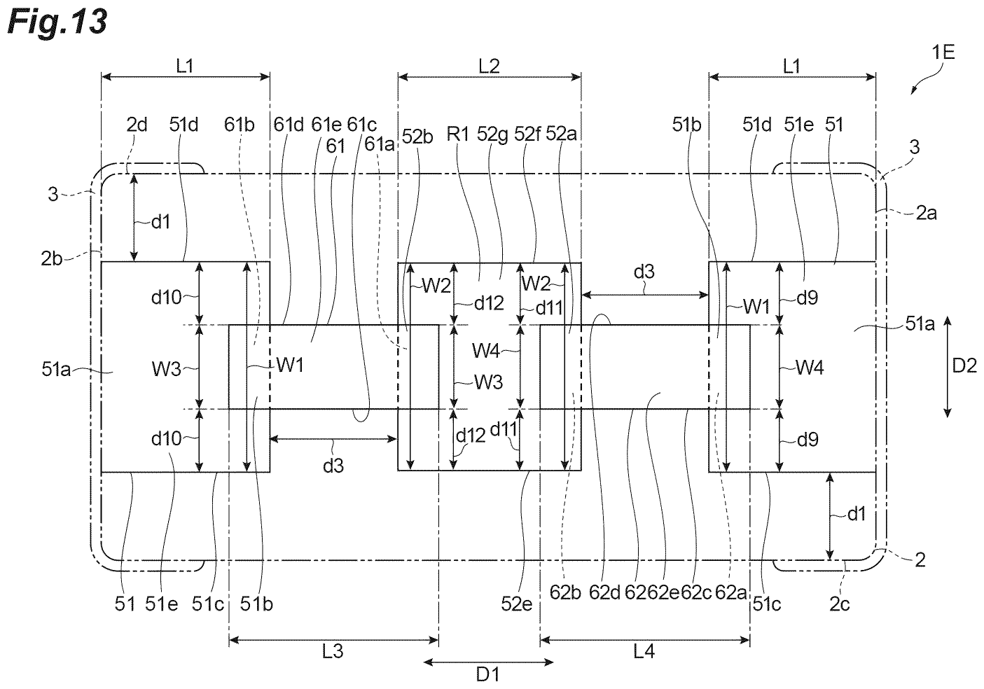

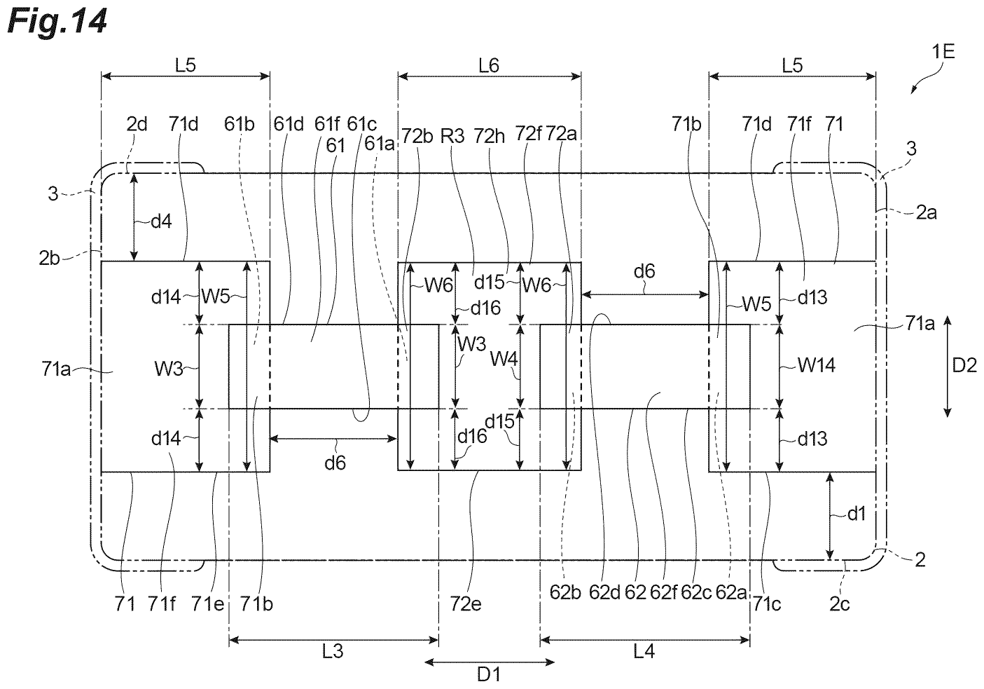

Next, a configuration of a chip varistor 1E according to a fifth modified example of the present embodiment will be described with reference to FIGS. 12, 13, and 14. FIG. 12 is a perspective view of a chip varistor according to still another modification of the present embodiment. FIG. 13 is a view illustrating the configuration of the plurality of internal electrodes, and is a view of the pair of internal electrodes 51 and the internal electrode 52 and the internal electrodes 61 and 62 when viewed in a direction from the side surface 2e toward the side surface 2f in the third direction D3. FIG. 14 is a view illustrating the configuration of the plurality of internal electrodes, and is a view of the internal electrodes 61 and 62, the pair of internal electrodes 71 and the internal electrode 72 when viewed in a direction from the side surface 2f toward the side surface 2e in the third direction D3. The chip varistor 1E is different from the chip varistor 1 described above in terms of the configuration of the plurality of internal electrodes. Hereinafter, the differences between the chip varistor 1 described above and the chip varistor 1E will be mainly described.

In the present modified example, the chip varistor 1E includes the plurality of external electrodes 3. That is, the chip varistor 1E does not include the plurality of external electrodes 4. In the present modified example, the internal electrode 52 includes the pair of ends 52a and 52b, the pair of end edges 52e and 52f, and the pair of surfaces 52g and 52h opposing each other, and does not include the pair of ends 52c and 52d. Therefore, in the present modified example, the internal electrode 52 is not exposed to the pair of side surfaces 2c and 2d. In the present modified example, the pair of end edges 52e and 52f opposes each other in the second direction D2. Each of the end edges 52e and 52f may include a surface.

In the present modified example, in order to realize a configuration in which the internal electrode 52 is not exposed to the pair of side surfaces 2c and 2d, the surface 52g and the surface 52h include only one surface region R3. Also, in the present modified example, for example, a part of the surface region R3 is included in the end 52a, and another part of the surface region R3 positioned on the opposite side to the part of the surface region R3 in the first direction D1 is included in the end 52b.

In the present modified example, the internal electrode 72 includes the pair of ends 72a and 72b, the pair of end edges 72e and 72f, and the pair of surfaces 72g and 72h opposing each other, and does not include the pair of ends 72c and 72d. Therefore, in the present modified example, the internal electrode 72 is not exposed to the pair of side surfaces 2c and 2d. In the present modified example, the pair of end edges 72e and 72f opposes each other in the second direction D2. Each of the end edges 72e and 72f may include a surface.

In the present modified example, in order to realize a configuration in which the internal electrode 72 is not exposed to the pair of side surfaces 2c and 2d, the surface 72g and the surface 72h include only one surface region R3. In the present modified example as well, for example, a part of the surface region R3 is included in the end 72a, and another part of the surface region R3 positioned on the opposite side to the part of the surface region R3 in the first direction D1 is included in the end 72b.

Any one of the magnitude relationships of each of the widths W1 to W6 in the chip varistors 1A and 1B may be adopted as the magnitude relationships of each of the widths W1 to W6 in the present modified example.

The width W1 of the internal electrode 51 exposed to the side surface 2a may be smaller than the width W4 at the end 62a. The width W1 of the internal electrode 51 exposed to the side surface 2b may be smaller than the width W3 at the end 61b. The width W2 at the end 52a may be smaller than the width W4 at the end 62b. The width W2 at the end 52b may be smaller than the width W3 at the end 61a.

The width W5 of the internal electrode 71 exposed to the side surface 2a may be smaller than the width W4 at the end 62a. The width W5 of the internal electrode 71 exposed to the side surface 2b may be smaller than the width W3 at the end 61b. The width W6 at the end 72a may be smaller than the width W4 at the end 62b. The width W6 at the end 72b may be smaller than the width W3 at the end 61a.

The characteristics include, for example, tolerance of capacitance. The tolerance of the capacitance is affected by the area of the region where the internal electrodes opposing each other overlap each other in the chip varistors 1, 1A, 1B, 1C, 1D, and 1E. As described above, in each of the chip varistors 1, 1A, 1B, 1C, 1D, and 1E, regardless of the relative positions in a width direction of the internal electrodes opposing each other, the overlapping area tends not to change. As a result, regardless of the relative positions of the internal electrodes opposing each other in the second direction D2, each of the chip varistors 1, 1A, 1B, 1C, 1D, and 1E can keep the tolerance of the capacitance within a desired range.

Although an embodiment and modified examples of the present disclosure have been described above, the present disclosure is not necessarily limited to the above-described embodiment and modified examples, and various modifications can be made without departing from the gist thereof.

In the above-described embodiment and each modified example, the chip varistors 1, 1A, 1B, 1C, and 1D include the pair of external electrodes 4. However, the chip varistors 1, 1A, 1B, 1C, and 1D may include one external electrode 4. In a configuration in which the chip varistors 1, 1A, 1B, 1C, and 1D include one external electrode 4, the internal electrodes 52 and 72 may be exposed to the side surface on which the external electrode 4 is disposed, of the pair of side surfaces 2c and 2d. In the configuration in which the chip varistors 1, 1A, 1B, 1C, and 1D include one external electrode 4, the internal electrode 52 may include only the end corresponding to the side surface on which the one external electrode 4 is disposed, of the pair of ends 52c and 52d. In the configuration in which the chip varistors 1, 1A, 1B, 1C, and 1D include one external electrode 4, the internal electrode 72 may include only the end corresponding to the side surface on which the one external electrode 4 is disposed, of the pair of ends 72c and 72d.

In the above-described embodiment and modified examples, the number of the internal electrodes 52 and 72 is “1”, but the number of the internal electrodes 52 and 72 is not limited to the above-described number. The number of the internal electrodes 52 and 72 may be “2” or more. That is, the internal electrode layer 5 may include a plurality of internal electrodes 52, and the internal electrode layer 7 may include a plurality of internal electrodes 72. In a configuration in which the internal electrode layer 5 includes a plurality of internal electrodes 52 and the internal electrode layer 7 includes a plurality of internal electrodes 72, the internal electrode layer 6 may include another internal electrode positioned between the internal electrode 61 and the internal electrode 62 in the first direction D1. The another internal electrode is disposed to form, for example, a plurality of varistors connected in series among the plurality of internal electrodes 52. For example, in a configuration in which the number of the plurality of internal electrodes 52 and the number of the plurality of internal electrodes 72 are “n”, the number of the another internal electrodes is “n-1”.

What is claimed is:

1. A chip varistor comprising:
an element body including a first side surface and a second side surface; and
a plurality of internal electrodes disposed in the element body and opposing each other, wherein
the plurality of internal electrodes include:
a first internal electrode exposed to the first side surface;
a second internal electrode exposed to the second side surface;
a third internal electrode separated from the first internal electrode and the second internal electrode;
a fourth internal electrode disposed to form a plurality of varistors connected in series between the first internal electrode and the third internal electrode; and
a fifth internal electrode disposed to form a plurality of varistors connected in series between the second internal electrode and the third internal electrode, and
among the plurality of internal electrodes, the internal electrodes opposing each other include ends opposing each other and having different widths.

2. The chip varistor according to claim 1, wherein
each of the first internal electrode and the third internal electrode includes an end opposing the fourth internal electrode,
the fourth internal electrode includes an end opposing the end of the first internal electrode and having a width smaller than a width of the end of the first internal electrode, and an end opposing the end of the third internal electrode and having a width smaller than a width of the end of the third internal electrode,
each of the second internal electrode and the third internal electrode includes an end opposing the fifth internal electrode and, the fifth internal electrode includes an end opposing the end of the second internal electrode and having a width smaller than a width of the end of the second internal electrode, and an end opposing the end of the third internal electrode and having a width smaller than a width of the end of the third internal electrode.

3. The chip varistor according to claim 1, wherein
each of the first internal electrode and the third internal electrode includes an end opposing the fourth internal electrode,
the fourth internal electrode includes an end opposing the end of the first internal electrode and having a width smaller than a width of the end of the first internal electrode, and an end opposing the end of the third internal electrode and having a width larger than a width of the end of the third internal electrode,
each of the second internal electrode and the third internal electrode includes an end opposing the fifth internal electrode and,
the fifth internal electrode includes an end opposing the end of the second internal electrode and having a width smaller than a width of the end of the second internal electrode, and an end opposing the end of the third internal electrode and having a width larger than a width of the end of the third internal electrode.

4. The chip varistor according to claim 1, wherein
the first internal electrode, the second internal electrode, and the third internal electrode have the same width.

5. The chip varistor according to claim 1, further comprising:
a plurality of external electrodes disposed on the element body and separated from each other, wherein
the element body includes a third side surface coupling the first side surface and the second side surface,
the third internal electrode is exposed to the third side surface, and
each of the plurality of external electrodes is connected to a corresponding internal electrode among the first internal electrode, the second internal electrode, and the third internal electrode.

6. The chip varistor according to claim 1, wherein
the plurality of internal electrodes include:
a first electrode layer including the first internal electrode, the second internal electrode, and the third internal electrode positioned in the same layer;
a second electrode layer including the fourth internal electrode opposing the first internal electrode and the third internal electrode, and the fifth internal electrode opposing the second internal electrode and the third internal electrode which are positioned in the same layer, and adjacent to the first electrode layer; and
a third electrode layer adjacent to the second electrode layer in such a manner that the second electrode layer is positioned between the third electrode layer and the first electrode layer, and
the third electrode layer includes:
a sixth internal electrode exposed to the first side surface and opposing the fourth internal electrode opposing the first internal electrode and the third internal electrode;
a seventh internal electrode exposed to the second side surface and opposing the fifth internal electrode opposing the second internal electrode and the third internal electrode; and
an eighth internal electrode opposing the sixth internal electrode and the seventh internal electrode.
